(19) United States
(12) Patent Application Publication
(10) Pub. No.: US 2017/0310601 A1
(43) Pub. Date: Oct. 26, 2017

(54) RADIO-AWARE TRANSMISSION CONTROL PROTOCOL RATE CONTROL

(71) Applicant: QUALCOMM Incorporated, San Diego, CA (US)

(72) Inventors: Yu-Ting Yu, Somerset, NJ (US); Vincent Douglas Park, Budd Lake, NJ (US); Gavin Bernard Horn, La Jolla, CA (US)

(21) Appl. No.: 15/269,593

(22) Filed: Sep. 19, 2016

Related U.S. Application Data
(60) Provisional application No. 62/325,976, filed on Apr. 21, 2016.

(51) Int. Cl. H04L 12/807; H04L 12/26; H04L 29/06; H04L 29/08

(52) U.S. Cl. CPC H04L 47/27; H04L 69/161; H04L 43/0876; H04L 67/28

(57) ABSTRACT

Techniques are described for wireless communication. One method includes monitoring a dynamic connection parameter associated with a Transmission Control Protocol (TCP) connection between a mobile device and an end device; identifying a TCP (acknowledgement) ACK message comprising a current receive window size; determining an updated receive window size based at least in part on the monitored dynamic connection parameter and the current receive window size; and transmitting, to the end device, the TCP ACK message comprising the updated receive window size.

### CROSS REFERENCES

The present application for patent claims priority to U.S. Provisional Patent Application No. 62/325,976 by YU et al., entitled “Radio-Aware Transmission Control Protocol Rate Control,” filed Apr. 21, 2016, assigned to the assignee hereof, and hereby expressly incorporated by reference herein in its entirety.

### INTRODUCTION

The following relates generally to wireless communication, and more specifically to radio-aware transmission control protocol (TCP) rate control.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may each be referred to as a user equipment (UE).

In some examples, a TCP may employ numerous flow control or congestion control techniques in an attempt to prevent packet loss or system collapse (e.g., due to a lack of harmony between TCP control techniques and interaction with the wireless communications system). For flow control, in some examples, a TCP receiver may determine a receive window that indicates, to a TCP sender, the amount of data the TCP receiver is able to receive and/or buffer. In other examples, for congestion control, TCP mechanisms are employed to vary the size of a TCP congestion window based on a throughput metric such as, a Bandwidth Delay Product (BDP). Additionally or alternatively, in some examples TCP control techniques assume that a round trip latency and path bandwidth (used to calculate BDP) do not change frequently during a TCP connection. In some aspects, this assumption may be unrealistic and the TCP congestion window may overshoot leading to severe packet losses.

In some example of high throughput (HT) or very HT (VHT) wireless communications systems, multiple TCP connections may interpret a random channel error as a congestion error and request retransmission unnecessarily. Such a burst of retransmission requests from the multiple TCP connections, in some aspects, may overload the TCP sender buffer(s). Additionally or alternatively, if the retransmission requests cannot be handled, the wireless communications system may become congested and devices connected to the TCP sender may be adversely affected.

### SUMMARY

A method of wireless communication at a TCP proxy is described. The method may include monitoring a dynamic connection parameter associated with a TCP connection between a mobile device and an end device, identifying a TCP acknowledgement (ACK) message comprising a current receive window size, determining an updated receive window size based at least in part on the monitored dynamic connection parameter and the current receive window size, and transmitting, to the end device, the TCP ACK message comprising the updated receive window size.

An apparatus for wireless communication is described. The apparatus may include a processor, memory in electronic communication with the processor. The processor and memory may be configured to monitor a dynamic connection parameter associated with a TCP connection between a mobile device and an end device, identify a TCP ACK message comprising a current receive window size, determine an updated receive window size based at least in part on the monitored dynamic connection parameter and the current receive window size, and transmit, to the end device, the TCP ACK message comprising the updated receive window size.

Another apparatus for wireless communication is described. The apparatus may include means for monitoring a dynamic connection parameter associated with a TCP connection between a mobile device and an end device, means for identifying a TCP ACK message comprising a current receive window size, means for determining an updated receive window size based at least in part on the monitored dynamic connection parameter and the current receive window size, and means for transmitting, to the end device, the TCP ACK message comprising the updated receive window size.

A non-transitory computer readable medium for wireless communication is described. The non-transitory computer-readable medium may include instructions operable to cause a processor to monitor a dynamic connection parameter associated with a TCP connection between a mobile device and an end device, identify a TCP ACK message comprising a current receive window size, determine an updated receive window size based at least in part on the monitored dynamic connection parameter and the current receive window size, and transmit, to the end device, the TCP ACK message comprising the updated receive window size.

Some examples of the method, apparatus, and non-transitory computer-readable medium described above may further include processes, features, means, or instructions for overwriting the current receive window size in a TCP header of the TCP ACK message received from the mobile device with the updated receive window size.

In some examples of the method, apparatus, and non-transitory computer-readable medium described above, the dynamic connection parameter comprises at least one of an end to end delay estimate of the TCP connection, or a data rate of the TCP connection, or a modulation coding scheme (MCS) associated with the TCP connection, or a minimum queue size of one or more on-path routers, or a queue size estimate of a base station connected to the mobile device, or a combination thereof.

Some examples of the method, apparatus, and non-transitory computer-readable medium described above, determining the updated receive window size comprises: determining a change in the monitored dynamic connection parameter. Some examples of the method, apparatus, and non-transitory computer-readable medium described above may further include processes, features, means, or instructions for adjusting the current receive window size based at least in part on the determined change. In some examples of the method, apparatus, and non-transitory computer-readable medium described above, adjusting the current receive window size comprises: reducing the current receive window size based at least in part on the monitored dynamic connection parameter.

In some examples of the method, apparatus, and non-transitory computer-readable medium described above may further include processes, features, means, or instructions for determining the updated receive window size is based at least in part on an estimated BDP.

In some examples of the method, apparatus, and non-transitory computer-readable medium described above, the TCP proxy is collocated with the mobile device, the end device, or a network node along a path of the TCP connection. In some examples of the method, apparatus, or non-transitory computer-readable medium described above, determining the updated receive window size comprises: calculating a maximum receive window size based at least in part on the monitored dynamic connection parameter. Some examples of the method, apparatus, and non-transitory computer-readable medium described above may further include processes, features, means, or instructions for selecting the updated receive window size based on a minimum of the calculated maximum receive window size and the current receive window size received from the mobile device in the TCP ACK message.

A method of wireless communication at a TCP proxy is described. The method may include establishing a TCP connection with an end device, determining a dynamic connection parameter associated with the TCP connection, receiving, from a TCP proxy, an indicator associated with a change in the established TCP connection, and adjusting the dynamic connection parameter based at least in part on the received indicator.

An apparatus for wireless communication is described. The apparatus may include a processor, memory in electronic communication with the processor. The processor and memory may be configured to establish a TCP connection with an end device, determine a dynamic connection parameter associated with the TCP connection, receive, from a TCP proxy, an indicator associated with a change in the established TCP connection, and adjust the dynamic connection parameter based at least in part on the received indicator.

Another apparatus for wireless communication is described. The apparatus may include means for establishing a TCP connection with an end device, means for determining a dynamic connection parameter associated with the TCP connection, means for receiving, from a TCP proxy, an indicator associated with a change in the established TCP connection, and means for adjusting the dynamic connection parameter based at least in part on the received indicator.

A non-transitory computer readable medium for wireless communication is described. The non-transitory computer-readable medium may include instructions operable to cause a processor to establish a TCP connection with an end device, determine a dynamic connection parameter associated with the TCP connection, receive, from a TCP proxy, an indicator associated with a change in the established TCP connection, and adjust the dynamic connection parameter based at least in part on the received indicator.

In some examples of the method, apparatus, and non-transitory computer-readable medium described above, adjusting the dynamic connection parameter comprises: estimating or suspending estimation of at least one of a smoothed round trip time associated with the TCP connection, or a congestion window size, or a retransmission timeout, or a receive window size, or a combination thereof.

Some examples of the method, apparatus, and non-transitory computer-readable medium described above may further include processes, features, means, or instructions for determining the dynamic connection parameter associated with the TCP connection is based at least in part on at least one of a connection profile associated with the TCP connection, or a MCS, or upon reception of a TCP ACK message, or upon reception of a TCP negative ACK message, or a BDP, or a combination thereof.

In some examples of the method, apparatus, and non-transitory computer-readable medium described above, determining the dynamic connection parameter associated with the TCP connection comprises: estimating at least one of a smoothed round trip time associated with the TCP connection, or a congestion window size, or a retransmission timeout, or a receive window size, or a combination thereof.

In some examples of the method, apparatus, and non-transitory computer-readable medium described above, the change in the TCP connection comprises at least one of a beginning of a handover event, or an end of a handover event, or a change in a data rate of the TCP connection, or a change in an end to end delay estimate of the TCP connection, or an indication of congestion control status, or an indication of retransmission failure, or a combination thereof.

In some examples of the method, apparatus, and non-transitory computer-readable medium described above, the received indicator comprises a suggested congestion window size, a suggested retransmission timeout, or a suggested receive window size.

### BRIEF DESCRIPTION OF THE DRAWINGS

FIG. 1 illustrates an example of a wireless communications system that supports radio-aware TCP rate control, in accordance with one or more aspects of the present disclosure;

FIG. 2 illustrates an example of a wireless communications system that supports radio-aware TCP rate control in accordance with one or more aspects of the present disclosure;

FIGS. 3 through 5 illustrate examples of process flows that support radio-aware TCP rate control in accordance with one or more aspects of the present disclosure;

FIGS. 6 through 8 show block diagrams of a wireless device that supports radio-aware TCP rate control in accordance with one or more aspects of the present disclosure;

FIG. 9 illustrates a block diagram of a system including a base station that supports radio-aware TCP rate control in accordance with one or more aspects of the present disclosure;

FIGS. 10 through 12 show block diagrams of a wireless device that supports radio-aware TCP rate control in accordance with one or more aspects of the present disclosure;

FIG. 13 illustrates a block diagram of a system including a UE that supports radio-aware TCP rate control in accordance with one or more aspects of the present disclosure;

FIG. 14 is a flow chart illustrating an example method for radio-aware TCP rate control in accordance with one or more aspects of the present disclosure;

FIG. 15 is a flow chart illustrating an example method for radio-aware TCP rate control in accordance with one or more aspects of the present disclosure;

FIG. 16 is a flow chart illustrating an example method for radio-aware TCP rate control in accordance with one or more aspects of the present disclosure;

FIG. 17 is a flow chart illustrating an example method for radio-aware TCP rate control in accordance with one or more aspects of the present disclosure; and

FIG. 18 is a flow chart illustrating an example method for radio-aware TCP rate control in accordance with one or more aspects of the present disclosure.

### DETAILED DESCRIPTION

Wireless communications systems may be packet-based systems that support transmission control protocol/internet protocol (TCP/IP). TCP is a widely used transport protocol and may support a connection between a TCP sender and receiver. The TCP sender and the TCP receiver may be referred to as end devices. TCP supports use of a congestion window to control the amount of in-flight data, e.g., the amount of data being transmitted at any particular time between the TCP sender and receiver, or vice versa. In some aspects, the TCP congestion window may be determined by the TCP sender, which may periodically or continually increase the congestion window until a packet is lost. In some examples, TCP congestion control assumes a data packet loss is an indicator of a congestion event and reduces the congestion window when such an event is detected. In some aspects, such packet loss may not be as a result of congestions, but may randomly occur during communication due to random channel errors, interference, device mobility, weak signal strength, etc.

In some examples, a TCP proxy identifies, determines, or adjusts certain parameters associated with a TCP connection between a TCP sender and a TCP receiver. The TCP proxy, for example, may be located anywhere (or within any network entity) along the TCP connection path between the TCP sender and the TCP receiver. As a result, the TCP proxy may monitor the TCP connection to limit or maintain in-flight data in an attempt to prevent and/or mitigate network congestion and system failure.

In some aspects, TCP may also support techniques for flow control in which the TCP receiver may determine a receive window size indicating the amount of data the TCP receiver is able to buffer at a given time for a TCP connection. The receive window size may be transmitted to the TCP sender in a TCP ACK message and may indicate to the TCP sender the current buffer capabilities of the TCP receiver. In some examples, the TCP congestion window and the TCP receive window may not take into account current network conditions. For example, if the TCP connection incurs a network change (e.g., a beginning of a handover, and end of a handover, a change in data rate), the congestion window and the receive window may be too large (or in some cases, too small) and if communication between the TCP sender and receiver continued based on the current congestion window and the current receive window, network congestion or system failure may occur.

Aspects of the disclosure are initially described in the context of a wireless communication system. For example, a TCP proxy may monitor an active TCP connection between two end devices (e.g., the TCP sender or the TCP receiver). In some examples, based on the monitoring (e.g., if the TCP proxy identifies a change in the TCP connection), the TCP proxy may determine or adjust a dynamic connection parameter associated with the TCP connection. The TCP proxy may then transmit the adjusted or determined dynamic connection parameter in a TCP message (e.g., a TCP ACK message). In some examples, transmitting a TCP message (e.g., TCP ACK message, negative TCP ACK message) from a TCP proxy to a receiving wireless device may be based at least in part on a direct transmission. In other examples, transmitting a message from a TCP proxy to a receiving wireless device may be based at least in part on an in-direct transmission. For example, a receiving wireless device may be multiple hops (e.g., two or more hops) from the TCP proxy. As a result, the TCP proxy may forward the message by sending the message to one or more intermediate devices in-path of the receiving wireless device. The one or more intermediate devices in-path of the receiving wireless device may forward the message to the receiving wireless device. In some examples, the intermediate devices may include, other UEs or network nodes (e.g., UEs 115 or network nodes 130) within the wireless communication system 100. In some examples, the intermediate devices may include, base station 105 within the wireless communication system 100. Additionally or alternatively, the TCP proxy, in some examples, may transmit an indicator to the TCP sender or the TCP receiver that indicates a change in the TCP connection. The TCP proxy may, additionally or alternatively, include suggested parameters for the TCP sender or the TCP receiver based on the change in the TCP connection. In some aspects, the TCP sender or the TCP receiver may decide to update a dynamic connection parameter associated with the TCP connection based on the received indicator.

The present techniques described herein support transmission control protocol/internet protocol (TCP/IP). Additionally, the present techniques described herein provide a TCP proxy, the TCP proxy herein can monitor one or more connection parameters associated with a TCP connection. Further, the connection parameters described herein may be dynamic connection parameters that have a corresponding value(s) that changes based on one or more factors (e.g., change in smoothed round trip time (SRTT) or a change in retransmission timeout (RTO) associated with the TCP connection, a congestion window size, a receive window size, or a sender window size, among others) associated with a TCP connection. An example of dynamic connection parameters may include, but is not limited to, at least one of an end to end delay estimate of the TCP connection, or a data rate of the TCP connection, or a MCS associated with the TCP connection, or a minimum queue size of one or more on-path routers, or a queue size estimate of a base station connected to the mobile device, among others. Further, the present techniques described herein may determine an updated receive window size based on the monitored dynamic connection parameter as discussed elsewhere herein. Additionally, the present techniques described herein provide a TCP end device to establish a TCP connection with another end device and receive, from a TCP proxy, an indicator associated with a change in the established TCP connection.

In some examples, the TCP proxy may allow a TCP sender or a TCP receiver to determine dynamic connection parameter that more accurately reflect current conditions associated with the TCP connection. Additionally, the TCP proxy may be located anywhere along a connection path between the TCP sender and the TCP receiver and may serve as an intermediary that is capable of determining changes in a TCP connection quicker and more reliably than either of the end device. In some examples, the TCP proxy may be blind to either or both of the TCP sender and the TCP receiver. As a result, the TCP sender and the TCP receiver may not need to employ any additional techniques or allocate further resources for communication with the TCP proxy.

Aspects of the disclosure are further illustrated by and described with reference to apparatus diagrams, system diagrams, and flowcharts that relate to radio-aware TCP rate control.

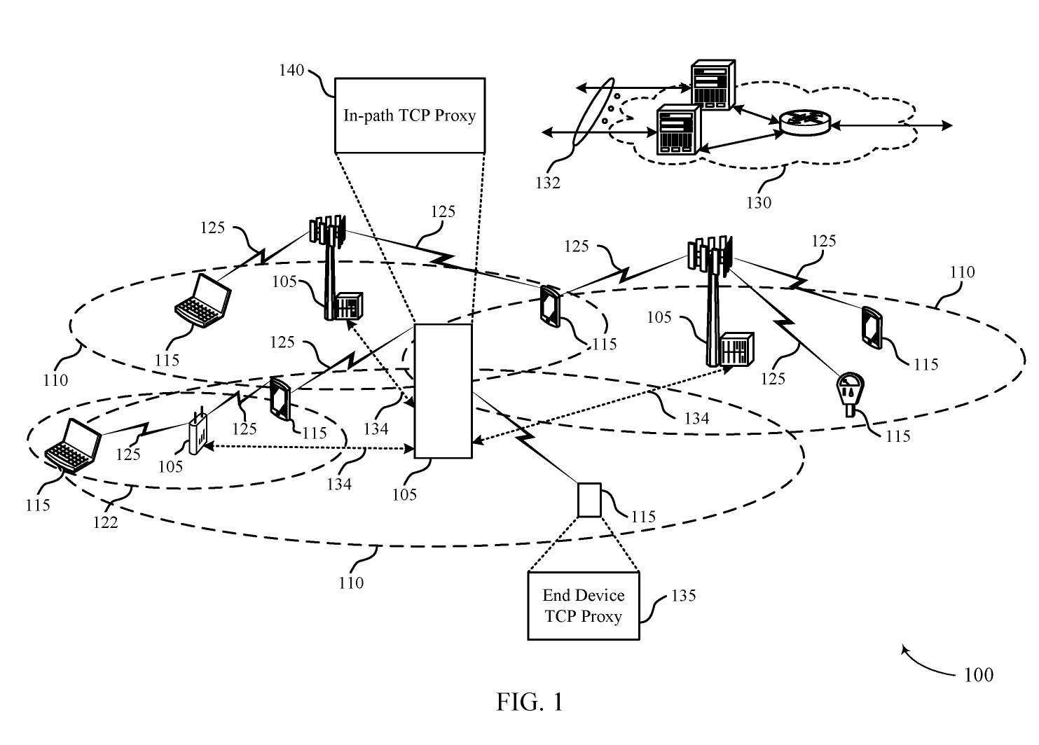

FIG. 1 illustrates an example of a wireless communications system that supports radio-aware TCP rate control, in accordance with one or more aspects of the present disclosure. The wireless communications system 100 includes base station 105, UE 115, and a core network 130. In some examples, the wireless communications system 100 may be a Long Term Evolution (LTE)/LTE-Advanced (LTE-A) network.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, mobile device, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, an machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

In some examples, wireless communications system 100 may utilize an enhanced component carrier (ECC). An ECC may be characterized by one or more features including: wider bandwidth, shorter symbol duration, shorter transmission time interval (TTI), and modified control channel configuration. In some examples, an ECC may be associated with a carrier aggregation configuration or a dual connectivity configuration (e.g., when multiple serving cells have a suboptimal or non-ideal backhaul link). An ECC may also be configured for use in unlicensed spectrum or shared spectrum (where more than one operator is allowed to use the spectrum). An ECC characterized by wide bandwidth may include one or more segments that may be utilized by UEs 115 that are not capable of monitoring the whole bandwidth or prefer to use a limited bandwidth (e.g., to conserve power).

In some examples, an ECC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing ECCs may transmit wideband signals (e.g., 20, 40, 60, 80 MHz., etc.) at reduced symbol durations (e.g., 16.67 microseconds). A TTI in ECC may consist of one or multiple symbols. In some examples, the TTI duration (that is, the number of symbols in a TTI) may be variable. In some examples, an ECC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing ECCs may transmit wideband signals (e.g., 20, 40, 60, 80 MHz., etc.) at reduced symbol durations (e.g., 16.67 microseconds). A TTI in ECC may consist of one or multiple symbols. In some examples, the TTI duration (that is, the number of symbols in a TTI) may be variable.

A base station 105 may be connected by an S1 interface to the core network 130. The core network may be an evolved packet core (EPC), which may include at least one mobility management entity (MME), at least one serving gateway (S-GW), and at least one public data network (PDN) gateway (P-GW). The MME may be the control node that processes the signaling between the UE 115 and the EPC. All user internet protocol (IP) packets may be transferred through the S-GW, which itself may be connected to the P-GW. The P-GW may provide IP address allocation as well as other functions. The P-GW may be connected to the network operators IP services. The operators IP services may include the Internet, the Intranet, an IP Multimedia Subsystem (IMS), and a Packet-Switched (PS) Streaming Service (PSS).

In some examples, a UE 115 may establish a TCP connection with a node (e.g., a S-GW) of the core network 130 in order to transmit and receive IP data packets. A TCP connection may employ TCP sender (e.g., the node of the core network 130 in DL) and TCP receiver (e.g., UE 115 in DL transmissions) control techniques used to limit network congestion and prevent system failure. For example, a TCP sender may determine a congestion window used to maintain a certain amount of in-flight data between the TCP sender and the TCP receiver. Additionally or alternatively, a TCP receiver may implement flow control techniques in which a TCP receiver indicates, to the TCP sender, a receive window size. The receive window size may relate to the amount of data the TCP sender is capable of receiving. Using the receive window size and the congestion window, data packets may be reliably communicated between the TCP sender and the TCP receiver.

In some examples, however, the receive window size and the congestion window size, among other dynamic connection parameters determined by the TCP sender or the TCP receiver, may not take into account changes in the active TCP connection. For example, when a handover event occurs, a UE 115 connected to a serving base station (e.g., base station 105) may attach to a different target base station. During this process, data to be transmitted from the serving base station (i.e., base station 105) to the UE 115 may instead be transmitted to a target base station (e.g., another base station 105) and stored in a buffer of the target base station until handover is completed. As such, TCP packets transmitted from a node of the core network 130 to the UE 115 undergoing handover may not be received by the UE until handover is completed. In some aspects, however, the reception delay due to handover may cause the TCP sender to determine that the packets were not successfully received. As a result, the TCP sender may adjust the congestion window based on the apparent unsuccessful reception. While described above in the context of handover, it should be understood that other changes to a TCP connection may be wrongly interpreted by the TCP sender or the TCP receiver, which may lead to an inaccurate determination of a dynamic connection parameters associated with the TCP connection.

Accordingly, a wireless communications system 100 may employ an in-path TCP proxy 140, which may be collocated with a base station 105, or an end device TCP proxy 135, which may be collocated with a UE 115. The in-path TCP proxy 140 and the end device TCP proxy 135 may be used to prevent inaccurate determinations of dynamic connection parameters associated with a TCP connection between a UE 115 and a node of the core network 130, among other entities. Though shown as being implemented in the base station 105, in-path TCP proxy 140 may be located anywhere along a TCP connection path between a TCP sender and a TCP receiver, and may even be collocated with or located near the TCP sender and/or the TCP receiver (i.e., at or near end devices of the TCP connection). Additionally or alternatively, although the end device TCP proxy 135 is shown as being implemented at UE 115, the end device TCP proxy 135 may be implemented at either or both of the end devices (e.g., a TCP sender, a TCP receiver) in a TCP connection.

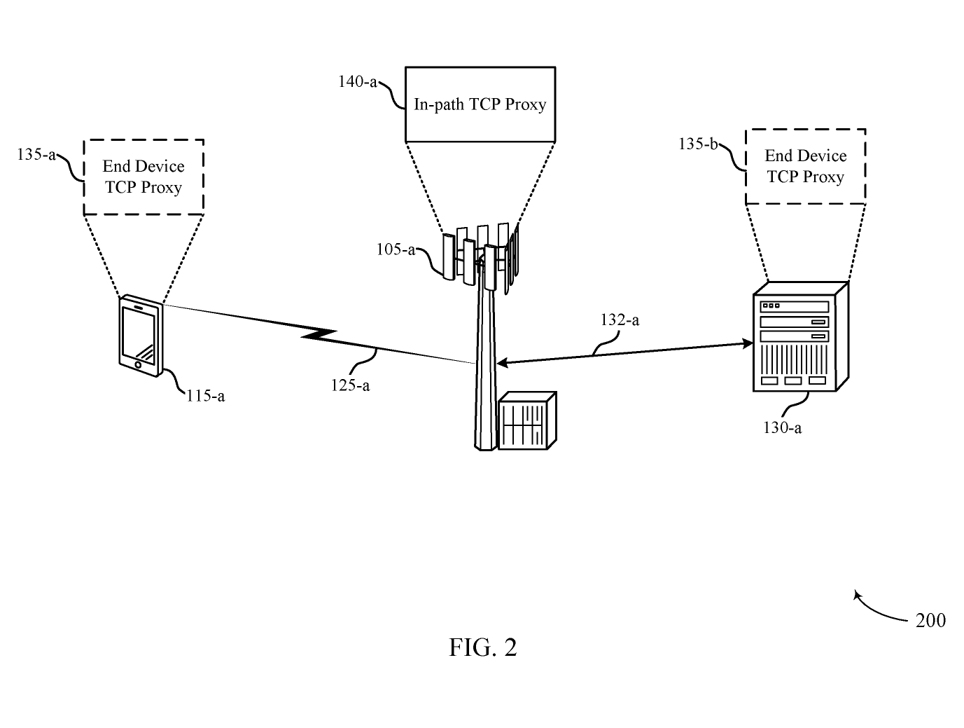

FIG. 2 illustrates an example of a wireless communications system 200 for radio-aware TCP rate control. Wireless communications system 200 may include base station 105-a and UE 115-a, which may be examples of the corresponding devices described with reference to FIG. 1. In some aspects, the wireless communications system 200 may also include a network node 130-a, which may be an example of any of the corresponding devices described with reference to FIG. 1.

The UE 115-a may establish a TCP connection with network node 130-a through base station 105-a. In some examples, the UE 115-a may connect to the base station 105-a through communication link 125-a, which may be an example of communication links 125 as described in FIG. 1. The base station 105-a may also connect to network node 130-a of a core network (e.g., core network 130 in FIG. 1) through a backhaul link 132-a (e.g., S1). In some examples, using the established TCP connection, UE 115-a may communicate with network node 130-a through transmission and reception of IP data packets.

The UE 115-a may determine a current receive window size associated with the established TCP connection. The current receive window size may be based on the UE 115-a capabilities, active TCP connections, overhead associated with the UE 115-a and other connections, among other factors. In some examples, the current receive window size may represent the amount of IP data packets that the UE 115-a is capable of receiving at a given time. The current receive window size may be one technique used in TCP for flow control in which the TCP receiver (e.g., UE 115-a in DL) may indicate how much data that may be reliably received and processed by the TCP receiver.

The current receive window size calculated by the UE 115-a may then be transmitted in a TCP message to the network node 130-a through the base station 105-a. The current receive window size may be transmitted in a TCP ACK message to the network node 130-a after successful receipt of IP packets transmitted by the network node 130-a. In some examples, the current receive window size may be transmitted in a header of the TCP ACK message. In other examples, the current receive window size may be transmitted in a separate message or included with another TCP message transmitted by the UE 115-a to the network node 130-a. In some examples, transmitting a data packet (e.g., TCP ACK message, negative TCP ACK message) from a sending wireless device to a receiving wireless device may be based at least in part on a direct transmission. In other examples, transmitting a message from a sending wireless device to a receiving wireless device may be based at least in part on an in-direct transmission. For example, a receiving wireless device may be multiple hops (e.g., two or more hops) from the sending device. As a result, the sending wireless device may forward the message by sending the message to one or more intermediate devices in-path to the receiving wireless device. The one or more intermediate devices in-path of the receiving wireless device may forward the message to the receiving wireless device. In some examples, the intermediate devices may include, other UEs or network nodes (e.g., UEs 115 or network nodes 130) within the wireless communication system 100. In some examples, the intermediate devices may include, base stations 105 within the wireless communication system 100. In some aspects, the intermediate devices may determine to forward a received message from the sending wireless device based at least in part on information provided in a header of the message.

The network node 130-a (e.g., the TCP sender in downlink) may also implement a number of TCP control techniques. For example, the network node 130-a may determine a current sender window size. The current sender window size may be based on the network node 130-a capabilities, active TCP connections, overhead associated with the network node 130-a and other connections, among other factors. The current sender window size may represent the amount of IP data packets that the network node 130-a is capable of sending at a given time. The current sender window size may be one technique used in TCP indicating how much data that may be reliably encoded and transmitted by the TCP sender.

Additionally or alternatively, the network node 130-a may determine a congestion window size used to control the in-flight data and data rate in order to prevent congestion collapse. The congestion window size may be determined based on number of active TCP connections, amount of data being transmitted and received, or other factors related to the number of data packets or amount of data associated with a TCP connection. The congestion window size may vary over time and may increase and/or decrease based on the number of ACKs or negative ACKs received from a TCP receiver. In some examples, the congestion window size may also be based on round trip time or the BDP associated with a TCP connection.

In some examples, monitoring a TCP connection between a first device and a second device may include monitoring a direction communication between the first device and the second device. In some examples, the first device may be the base station 105-a and the second device may be the UE 115-a. In one example, the base station 105-a may monitor the TCP connection between the UE 115-a and the base station 105-a directly. In some examples, the base station 105-a may communicate via a TCP connection with the UE 115-a through one or more intermediate device, for example, a relay device, or other UEs 115, or other base station(s) 105, or a combination thereof. In some examples, the base station 105-a may monitor the TCP connection with the UE 115-a base at least in part on the one or more intermediate devices in-path of the base station 105-a and the UE 115-a. In some examples, monitoring the TCP connection may include monitoring a dynamic connection parameter. In some examples, as described elsewhere herein the base station 105-a may monitor the dynamic connection parameter associated with the TCP connection directly. In other examples, the base station 105-a may monitor the dynamic connection parameter associated with the TCP connection indirectly, for examples, based at least in part on the one or more intermediate devices in-path of the base station 105 and the UE 115 as described with reference to FIG. 1. In some aspects, monitoring a TCP connection between a UE (e.g., UE 115-a) and network node (e.g., network node 130-a) may be performed by an intermediate device (e.g., base station 105-a). In some examples, monitoring the TCP connection between the UE 115-a and the network node 130-a may be performed directly.

In some examples, the base station 105-a may include an in-path TCP proxy 140-a that monitors the TCP connection between UE 115-a and network node 130-a in order to prevent congestion or system collapse. The in-path TCP proxy 140-a may monitor or estimate a dynamic connection parameter associated with the TCP connection. The dynamic connection parameter may include statistics related to the TCP connection such as wired and wireless path bandwidths or delays association with the TCP connection such as the BDP associated with the TCP connection. The dynamic connection parameter may include an end to end delay estimate of the TCP connection or a data rate of the TCP connection. In some examples, the dynamic connection parameter may also include a MCS associated with the TCP connection or a buffer size of an entity along the connection path between the UE 115-a and the network node 130-a. For example, the in-path TCP proxy 140-a may monitor or estimate a minimum buffer size of any or all network entities along the TCP connection path. Other dynamic connection parameters may include a SRTT or a RTO associated with the TCP connection, a congestion window size, a receive window size, or a sender window size, as described above.

In other examples, the in-path TCP proxy 140-a may identify a connection profile associated with the TCP connection. For instance, a connection profile may be created for each MCS and may include different congestion window sizes, round trip time estimates, or other delay statistics based on the MCS. The connection profile may then be associated with an end device based on the MCS associated with TCP connections corresponding to the end device.

The in-path TCP proxy 140-a may identify a number of TCP ACK or negative TCP ACK messages, which may indicate a congestion control status or that the UE 115-a is moving toward an edge of a coverage area. In some examples, the number of TCP negative ACKs may be used to determine whether retransmission is successfully received and processed by the UE 115-a, which may indicate weaker signal strength or whether the UE 115-a is moving toward an edge of a coverage area, among other reasons. The in-path TCP proxy 140-a may, additionally or alternatively, monitor the TCP connection for any events or changes in the TCP connection. For example, the in-path TCP proxy 140-a may monitor the TCP connection for a beginning of a handover event or an end of a handover event, which may result in packet reception or transmission delay. The in-path TCP proxy 140-a may also determine a change in the data rate caused by weaker signal strength or interference, for example, or the in-path TCP proxy 140-a may estimate or determine a change in the end to end delay of the TCP connection due to mobility of the UE 115-a, for instance.

Based on the monitoring of the current receive window size as determined by the UE 115-a, the sender window size as determined by the network node 130-a, or the congestion window size as determined by network node 130-a, the in-path TCP proxy 140-a may determine or estimate an appropriate window size for the current network conditions. For example, if the in-path TCP proxy 140-a determines that the TCP connection or network is congested (e.g., based on buffer sizes associated with network entities), the in-path TCP proxy 140-a may calculate, update, or adjust (e.g., increase or decrease) the current receive window size. The updated receive window size may then be transmitted (e.g., in a TCP ACK message) from the in-path TCP proxy 140-a to the network node 130-a to limit the TCP data rate and prevent excessive transmissions or network overload that may occur as a result of changes or events associated with the TCP connection.

In some examples, the in-path TCP proxy 140-a may overwrite a current receive window size in a TCP header of the TCP ACK message received from the mobile device with the updated receive window size. The updated receive window size may be determined based on the minimum of the current receive window size determined by the UE 115-a and a maximum of the calculated or updated receive window size as determined by the in-path TCP proxy 140-a.

As shown in FIG. 2, the UE 115-a may optionally include an end device TCP proxy 135-a. The network node 130-a may also optionally include an end device TCP proxy 135-b, as shown. The end device TCP proxy 135-a and end device TCP proxy 135-b may be used to modify, update, or adjust a dynamic connection parameter associated with the TCP connection between the UE 115-a and the network node 130-a. If an end device TCP proxy (e.g., end device TCP proxy 135-a and end device TCP proxy 135-b) is employed, the in-path TCP proxy 140-a may monitor the TCP connection for an indicator that indicates an event or other change in the TCP connection. The in-path TCP proxy 140-a may then transmit the indicator to the UE 115-a to be processed by the end device TCP proxy 135-a or network node 130-a to be processed by the end device TCP proxy 135-b.

In some examples, upon receiving the indicator, the UE 115-a or the network node 130-a adjusts its congestion control or flow control techniques accordingly. For example, when receiving a handover event, end device TCP proxy 135-b may indicate to network node 130-a to suspend SRTT estimation in order to slow down congestion window growth or to prevent RTO increase. In some examples, the indicator may include a suggested congestion window size and the network node 130-a may update its congestion window size based on the suggested window size. In other examples, the indicator may include a suggested receive window size and the UE 115-a may update its current receive window size based on the suggested receive window size. Implementation of TCP proxies (e.g., in-path TCP proxy 140-a, end device TCP proxy 135-a, end device TCP proxy 135-b) may act as additional complementary techniques for congestion and flow control.

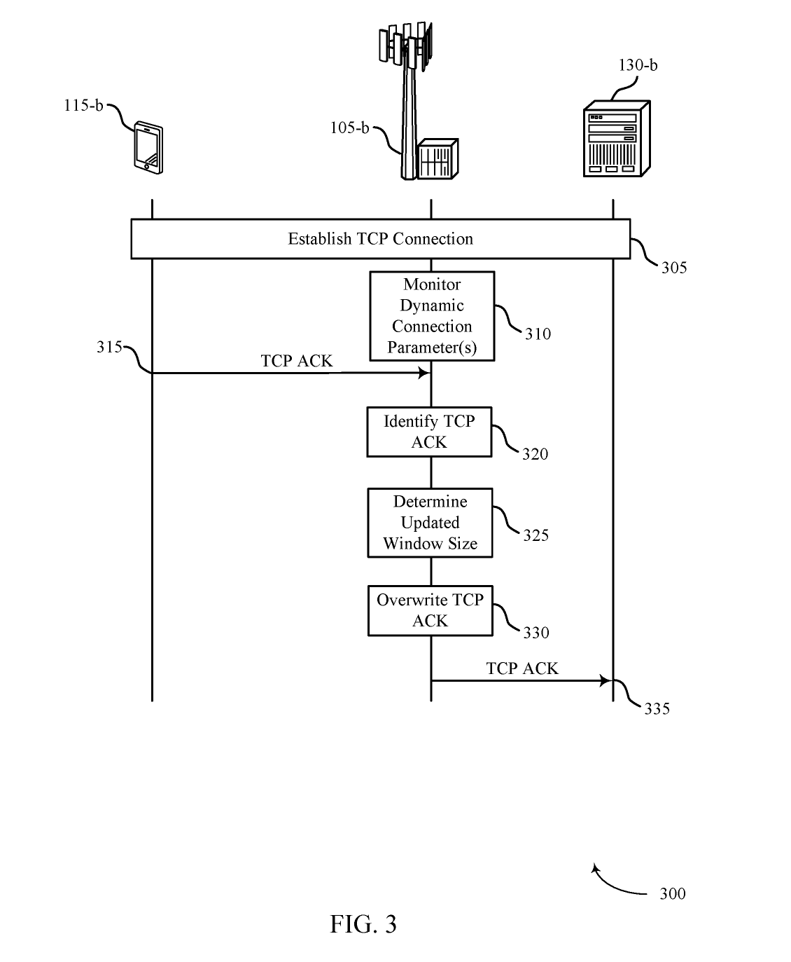

FIG. 3 illustrates an example of a process flow 300 for radio-aware TCP rate control. In some examples, process flow 300 may represent aspects of techniques performed by a UE 115, base station 105, or network node 130, as described with reference to FIGS. 1-2. In an example, an in-path TCP proxy (e.g., in-path TCP proxy 140 as described with reference to FIGS. 1-2) may be collocated with base station 105-b.

At 305, a TCP connection may be established between UE 115-b and network node 130-b. The TCP connection may be established to communicate IP data packets between UE 115-b and network node 130-b. At 310, the base station 105-b may monitor the TCP connection established at 305. In some aspects, the base station 105-b may monitor dynamic connection parameter(s) associated with the TCP connection. For examples, the base station 105-b may monitor delay statistics such as end to end connection delay and BDP, or messages transmitted and received over the TCP connection, among other parameters.

At 315, the UE 115-b may transmit a TCP ACK message intended for the network node 130-b. The TCP ACK message may include a current window size determined by the UE 115-b. The TCP ACK message may be received and identified by the base station 105-b at 320. In some examples, based on the received TCP ACK message and the dynamic connection parameters monitored at 310, the base station 105-b may determine an updated receive window size at 325. The updated receive window size may be greater than or less than the current receive window size and may be based on current conditions of the TCP connection as monitored by the base station 105-b. In some examples, after updating the receive window size, the base station 105-b may overwrite the current receive window size in the TCP ACK message at 330. In some examples, the base station 105-b may overwrite a TCP header of the TCP ACK message with the updated window size. Once the TCP ACK message is updated with the updated window size determined in 325, the base station 105-b transmits the TCP ACK message to the network node 130-b, at 335. In some examples, the network node 130-b may be multiple hops from the base station 105-b (not shown). As a result, transmitting the TCP ACK message to the network node 130-b may include the base station 105-b forwarding the TCP ACK message to one or more intermediate devices in a wireless communication system, and the one or more intermediate devices may forward the TCP ACK message to the network node 130-b.

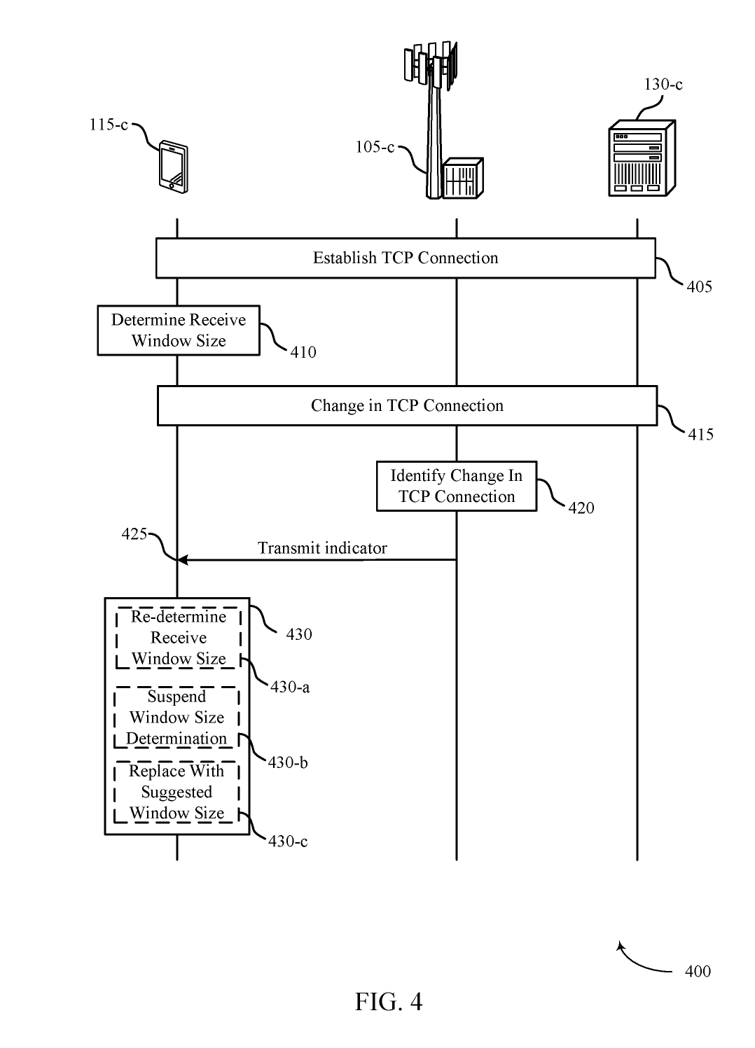

FIG. 4 illustrates an example of a process flow 400 for radio-aware TCP rate control. In some examples, process flow 400 may represent aspects of techniques performed by a UE 115, base station 105, or network node 130, as described with reference to FIGS. 1-2. In an example, an in-path TCP proxy (e.g., in-path TCP proxy 140 as described with reference to FIGS. 1-2) may be collocated with base station 105-c and an end device TCP proxy (e.g., end device TCP proxy 135 as described with reference to FIGS. 1-2) may be collocated with UE 115-c.

At 405, a TCP connection may be established between UE 115-c and network node 130-c. The TCP connection may be established to communicate IP data packets between UE 115-c and network node 130-c. At 410, UE 115-c may determine a receive window size associated with the TCP connection.

At 415, an event or change in the TCP connection may occur and at 420, the base station 105-c may identify the change in TCP connection at 420. Based on the change in TCP connection at 415, the base station 105-c may then transmit an indicator to UE 115-c at 425. The indicator may include information that indicates a change in the TCP connection or may include other parameters associated with the change in TCP connection. In some examples, transmitting an indicator that indicates a change in the TCP connection or other parameters associated with the change in the TCP connection from the base station 105-c to the UE 115-c may be based at least in part on a direct transmission. In other examples, transmitting an indicator from the base station 105-c to the UE 115-c may be based at least in part on an in-direct transmission. For example, UE 115-c may be multiple hops (e.g., two or more hops) from the base station 105-c. As a result, the base station 105-c may forward the indicator by sending the message to one or more intermediate devices in-path to the UE 115-c. The one or more intermediate devices in-path (not shown) of the UE 115-d may forward the indicator to the UE 115-d. In some examples, the intermediate devices may include, other UEs or network nodes (e.g., UEs 115 or network nodes 130) within the wireless communication system. In some examples, the intermediate devices may include, other base station(s) 105 within the wireless communication system 100 as described with reference to FIG. 1. In some aspects, the intermediate devices may determine to forward a received indicator from the sending wireless device based at least in part on information provided in a header of the indicator.

In some examples, upon receiving the indicator, the UE 115-c may adjust a dynamic connection parameter associated with the TCP connection at 430. For example, the UE 115-c may re-determine the receive window size at 430-a, suspend receive window size determination at 430-b, or replace its determined window size with a suggested window size at 430-c, as contained, for example, within the indicator transmitted at 425.

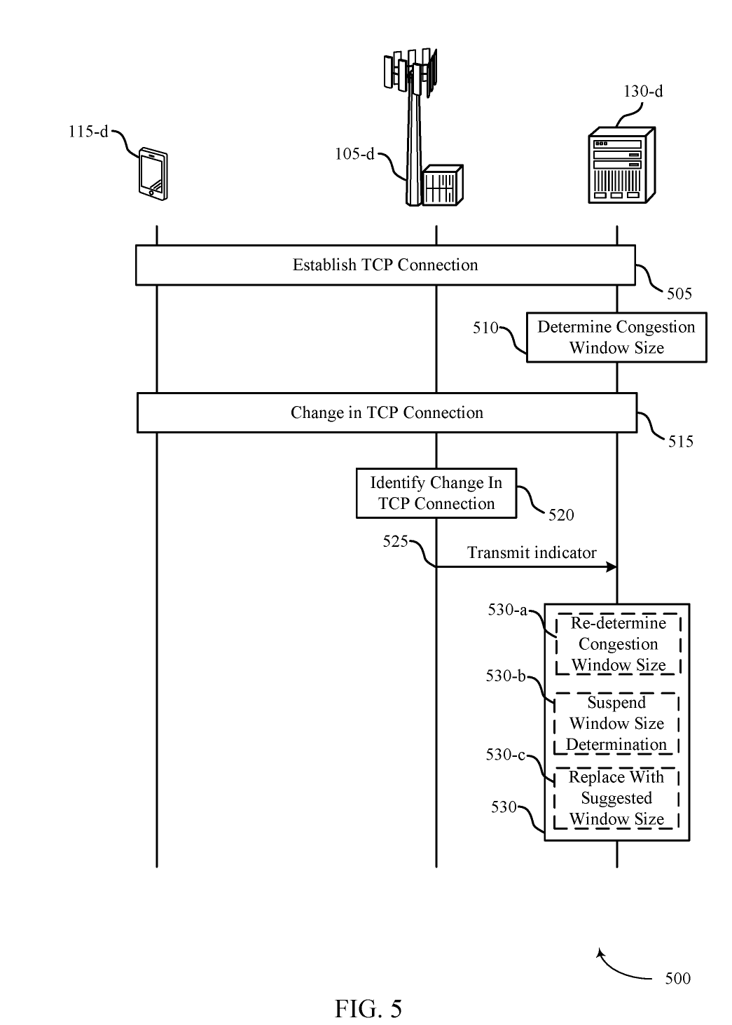

FIG. 5 illustrates an example of a process flow 500 for radio-aware TCP rate control. In some examples, process flow 500 may represent aspects of techniques performed by a UE 115, base station 105, or network node 130, as described with reference to FIGS. 1-2. In this example, an in-path TCP proxy (e.g., in-path TCP proxy 140 as described with reference to FIGS. 1-2) may be collocated with base station 105-d and an end device TCP proxy (e.g., end device TCP proxy 135 as described with reference to FIGS. 1-2) may be collocated with network node 130-d.

At 505, a TCP connection may be established between UE 115-d and network node 130-d. The TCP connection may be established to communicate IP data packets between UE 115-d and network node 130-d. At 510, network node 130-d may determine a congestion window size associated with the TCP connection.

At 515, an event or change in the TCP connection may occur and at 520, the base station 105-d may identify the change in TCP connection at 520. Based on the change in TCP connection at 515, the base station 105-d may then transmit an indicator to network node 130-d at 525. The indicator may include information that indicates a change in the TCP connection or may include other parameters associated with the change in TCP connection. In some examples, transmitting an indicator that indicates a change in the TCP connection or other parameters associated with the change in the TCP connection from the base station 105-d to the network node 130-d may be based at least in part on a direct transmission. In other examples, transmitting an indicator from the base station 105-d to the network node 130-d may be based at least in part on an in-direct transmission. For example, network node 130-d may be multiple hops (e.g., two or more hops) from the base station 105-d. As a result, the base station 105-d may forward the indicator by sending the message to one or more intermediate devices in-path to the network node 130-d. The one or more intermediate devices in-path (not shown) of the network node 130-d may forward the indicator to the network node 130-d. In some examples, the intermediate devices may include, other UEs or network nodes (e.g., UEs 115 or other base station(s) 105) within the wireless communication system.

In some examples, upon receiving the indicator, the network node 130-d may adjust a dynamic connection parameter associated with the TCP connection at 530. For example, the network node 130-d may re-determine the congestion window size at 530-a, suspend congestion window size determination at 530-b, or replace its determined congestion window size with a suggested window size at 530-c, as contained, for example, within the indicator transmitted at 525.

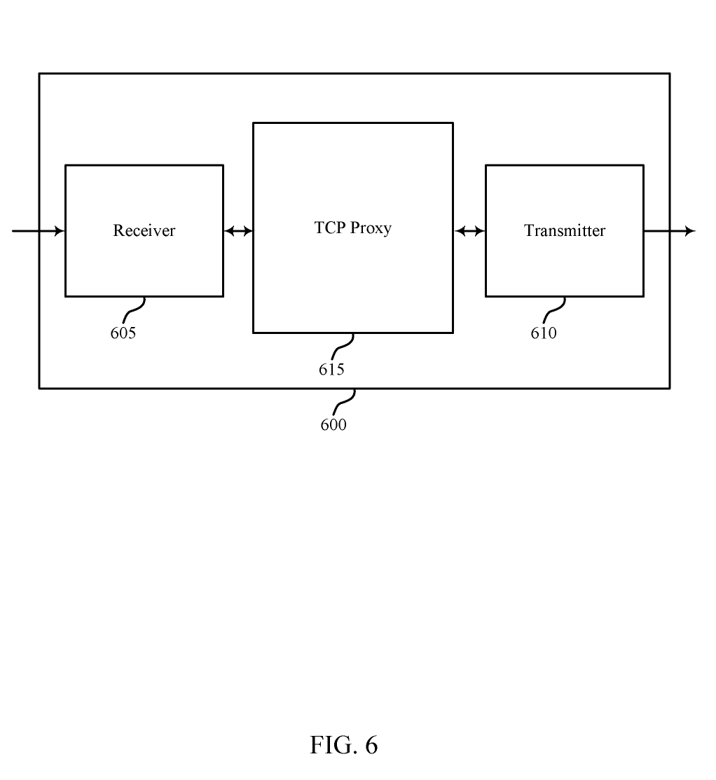

FIG. 6 shows a block diagram of a wireless device 600 that supports radio-aware TCP rate control in accordance with various aspects of the present disclosure. Wireless device 600 may be an example of aspects of a base station 105 or a network entity described with reference to FIGS. 1 and 2. Wireless device 600 may include receiver 605, transmitter 610, and TCP proxy 615. Wireless device 600 may also include a processor. Each of these components may be in communication with one another (e.g., via one or more buses).

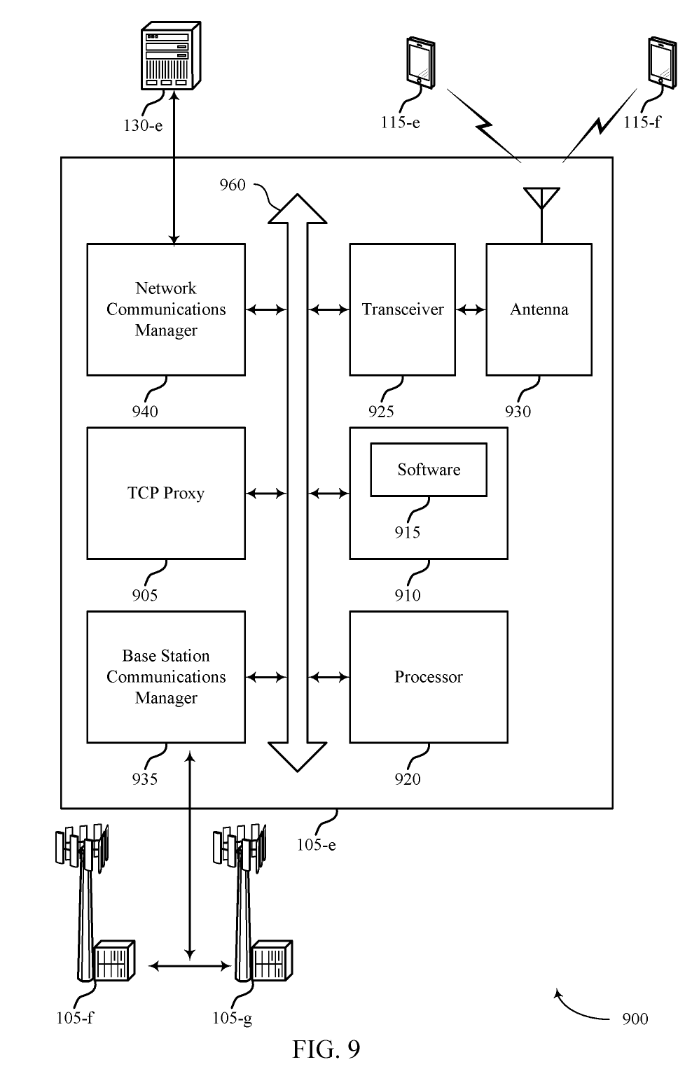

The receiver 605 may receive information such as packets, user data, or control information associated with various information channels (e.g., control channels, data channels, and information related to radio-aware TCP rate control, etc.). Information may be passed on to other components of the device. The receiver 605 may be an example of aspects of the transceiver 925 described with reference to FIG. 9.

The TCP proxy 615 may monitor a dynamic connection parameter associated with a TCP connection between a mobile device and an end device. In some aspects, the TCP proxy 615 may identify a TCP ACK message comprising a current receive window size. In some examples, the TCP proxy 615 may determine an updated receive window size based at least in part on the monitored dynamic connection parameter and the current receive window size and transmit, to the end device, the TCP ACK message comprising the updated receive window size. In some aspects, the TCP proxy 615 may also be an example of aspects of the TCP proxy 905 described with reference to FIG. 9.

The transmitter 610 may transmit signals received from other components of wireless device 600. In some examples, the transmitter 610 may be collocated with a receiver in a transceiver module. For example, the transmitter 610 may be an example of aspects of the transceiver 925 described with reference to FIG. 9. The transmitter 610 may include a single antenna, or it may include a plurality of antennas.

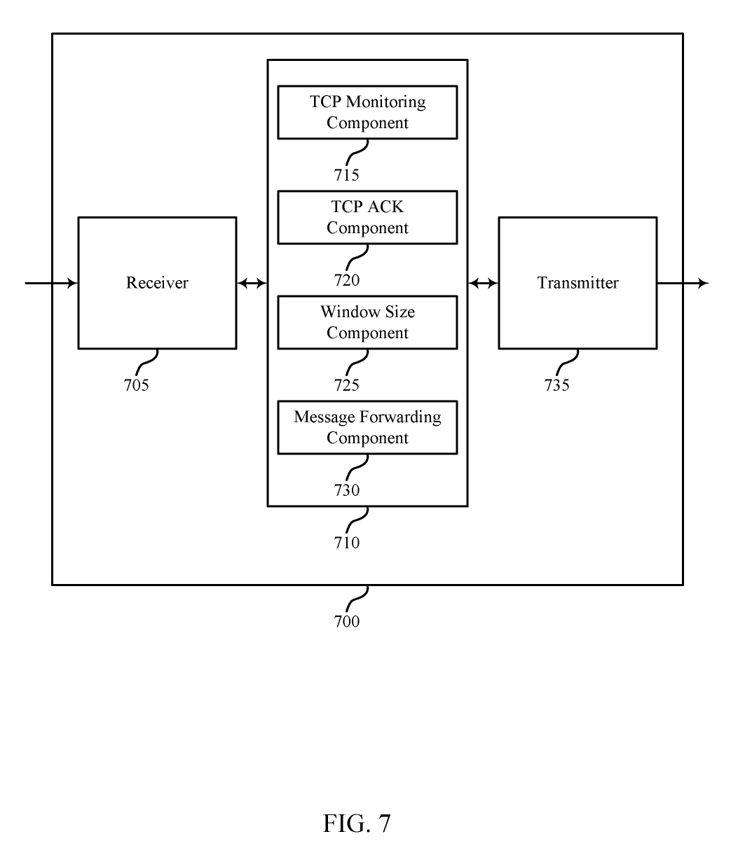

FIG. 7 shows a block diagram of a wireless device 700 that supports radio-aware TCP rate control in accordance with various aspects of the present disclosure. Wireless device 700 may be an example of aspects of a wireless device 600 or base station 105, or a network entity described with reference to FIGS. 1, 2, and 6. In some aspects, wireless device 700 may include receiver 705, TCP proxy 710, and transmitter 735. In some examples, wireless device 700 may also include a processor. The TCP proxy 710 may include TCP monitoring component 715, TCP ACK component 720, window size component 725, and message forwarding component 730. In some aspects, the TCP proxy 710 may be an example of aspects of the TCP proxy 905 described with reference to FIG. 9. Each of these components may communicate, directly or indirectly, with one another (e.g., via one or more buses). One or more of these components may perform various functions in combination with a receiver or a transmitter.

The receiver 705 may receive information which may be passed on to other components of the device. The receiver 705 may also perform the functions described with reference to the receiver 605 of FIG. 6. In some aspects, the receiver 705 may be an example of aspects of the transceiver 925 described with reference to FIG. 9. Each of these components may communicate, directly or indirectly, with one another (e.g., via one or more buses). One or more of these modules may perform various functions in combination with a receiver or a transmitter.

The TCP monitoring component 715 may monitor a dynamic connection parameter associated with a TCP connection between a mobile device and an end device. In some examples, the TCP parameter includes at least one of an end to end delay estimate of the TCP connection, or a data rate of the TCP connection, or a MCS associated with the TCP connection, or a minimum queue size of one or more on-path routers, or a queue size estimate of a base station connected to the mobile device, or a combination thereof.

The TCP ACK component 720 may identify a TCP ACK message comprising a current receive window size. In some examples, the TCP proxy is collocated with the mobile device, the end device, or a network node along a path of the TCP connection. In some aspects, the message forwarding component 730 may transmit, to the end device, the TCP ACK message comprising the updated receive window size.

In some aspects, the window size component 725 may adjust current receive window size based at least in part on the determined change. In some examples adjusting the current receive window size may include the window size component 725 reducing the current receive window size based at least in part on the monitored dynamic connection parameter. In further examples, adjusting the current receive window size may include the window size component 725 determining an updated receive window size based at least in part on an estimated BDP.

In some aspects, the window size component 725 may calculate a maximum receive window size based at least in part on the monitored dynamic connection parameter. In some examples, the window size component 725 may select an updated receive window size based on a minimum of the calculated maximum receive window size and the current receive window size received from the mobile device in the TCP ACK message.

The transmitter 735 may transmit signals received from other components of wireless device 700. In some examples, the transmitter 735 may be collocated with a receiver in a transceiver module. For example, the transmitter 735 may be an example of aspects of the transceiver 925 described with reference to FIG. 9. The transmitter 735 may utilize a single antenna, or it may utilize a plurality of antennas.

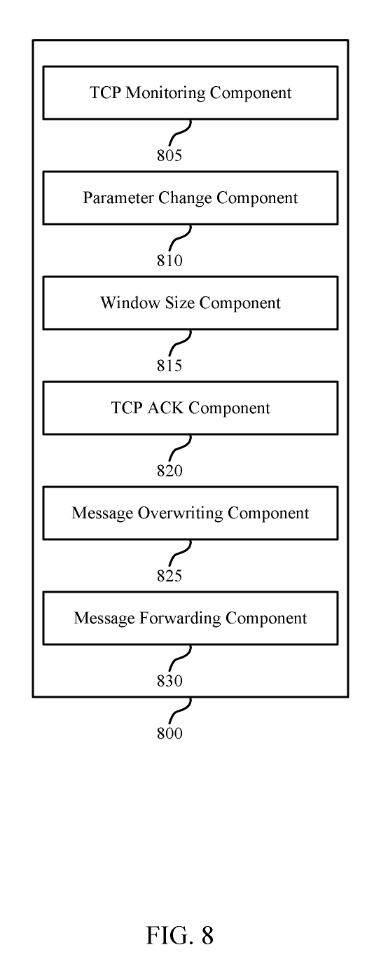

FIG. 8 shows a block diagram of a TCP proxy 800 which may be an example of the corresponding component of wireless device 600 or wireless device 700. That is, TCP proxy 800 may be an example of aspects of TCP proxy 615 or TCP proxy 710 described with reference to FIGS. 6 and 7. The TCP proxy 800 may also be an example of aspects of the TCP proxy 905 described with reference to FIG. 9. The TCP proxy 800 may include TCP monitoring component 805, parameter change component 810, window size component 815, TCP ACK component 820, message overwriting component 825 and message forwarding component 830. Each of these components may communicate, directly or indirectly, with one another (e.g., via one or more buses).

The TCP monitoring component 805 may monitor a dynamic connection parameter associated with a TCP connection between a mobile device and an end device. In some aspects, the parameter change component 810 may determine a change in the monitored dynamic connection parameter. In some examples, the change in the monitored dynamic connection parameter may be based on a change in the TCP connection. In some examples, the change in the TCP connection comprises at least one of a beginning of a handover event, or an end of a handover event, or a change in a data rate of the TCP connection, or a change in an end to end delay estimate of the TCP connection, or an indication of congestion control status, or an indication of retransmission failure, or a combination thereof.

In some aspects, the window size component 815 may adjust current receive window size based at least in part on the determined change. In some examples adjusting the current receive window size may include the window size component 815 reducing the current receive window size based at least in part on the monitored dynamic connection parameter. In further examples, adjusting the current receive window size may include the window size component 815 determining an updated receive window size based at least in part on an estimated BDP.

In some aspects, the window size component 815 may calculate a maximum receive window size based at least in part on the monitored dynamic connection parameter. In some examples, the window size component 815 may select an updated receive window size based on a minimum of the calculated maximum receive window size and the current receive window size received from the mobile device in the TCP ACK message.

In some examples, the TCP ACK component 820 may a TCP ACK message including a current receive window size. The message overwriting component 825 may overwrite the current receive window size in a TCP header of the TCP ACK message received from the mobile device with the updated receive window size. The message forwarding component 830 may transmit, to the end device, the TCP ACK message comprising the updated receive window size.

FIG. 9 illustrates a block diagram of a system 900 including a base station 105-e that supports radio-aware TCP rate control in accordance with one or more aspects of the present disclosure. Base station 105-e may be an example of or include the components of base station 105 a described above, e.g., with reference to FIGS. 1, 2, and 6-8. Base station 105-e may include components for bi-directional voice and data communications including components for transmitting and receiving communications, including TCP proxy 905, memory 910, software 915, processor 920, transceiver 925, antenna 930, base station communications manager 935, and network communications manager 940. These components may be in electronic communication directly or indirectly, with one another via one or more busses (e.g., bus 960). Base station 105-e may communicate wirelessly with one or more UEs 115 (UE 115-e or UE 115-f) or one or more base stations (base station 105-f or base station 105-g). The TCP proxy 905 may be an example of a TCP proxy as described with reference to FIGS. 6-8.

Memory 910 may include random access memory (RAM) and read only memory (ROM). In some examples, the memory 910 may store computer-readable, computer-executable software including instructions that, when executed, cause the processor to perform various functions described herein (e.g., radio-aware TCP rate control, etc.). In some cases, the memory 910 may contain, among other things, a basic input/output system (BIOS) which may control basic hardware and/or software operation such as the interaction with peripheral components or devices.

Software 915 may not be directly executable by the processor but may cause a computer (e.g., when compiled and executed) to perform functions described herein. The processor 920 may include an intelligent hardware device, (e.g., a central processing unit (CPU), a microcontroller, an application specific integrated circuit (ASIC), etc.)

Transceiver 925 may communicate bi-directionally, via one or more antennas, wired, or wireless links, with one or more networks, as described above. For example, the transceiver 925 may represent a wireless transceiver and may communicate bi-directionally with another wireless transceiver (e.g., located at UE 115-f or UE 115-g). The transceiver 925 may also include a modem to modulate the packets and provide the modulated packets to the antennas for transmission, and to demodulate packets received from the antennas. In some examples, the base station 105-e may include a single antenna 930. However, in some cases the base station 105-e may have more than one antenna 930, which may be capable of concurrently transmitting or receiving multiple wireless transmissions.

The base station communications manager 935 may manage communications with other base station(s) 105, and may include a controller or scheduler for controlling communications with UEs 115 in cooperation with other base station(s) 105 (e.g., base station 105-f and/or base station 105-g). For example, the base station communications manager 935 may coordinate scheduling for transmissions to UEs 115 for various interference mitigation techniques such as beamforming or joint transmission. In some examples, base station communications manager 935 may provide an X2 interface within an LTE/LTE-A wireless communication network technology to provide communication between base stations 105.

Network communications manager 940 may manage communications with the core network (e.g., via one or more wired backhaul links). For example, the network communications manager 940 may manage the transfer of data communications for client devices, such as one or more UEs 115.

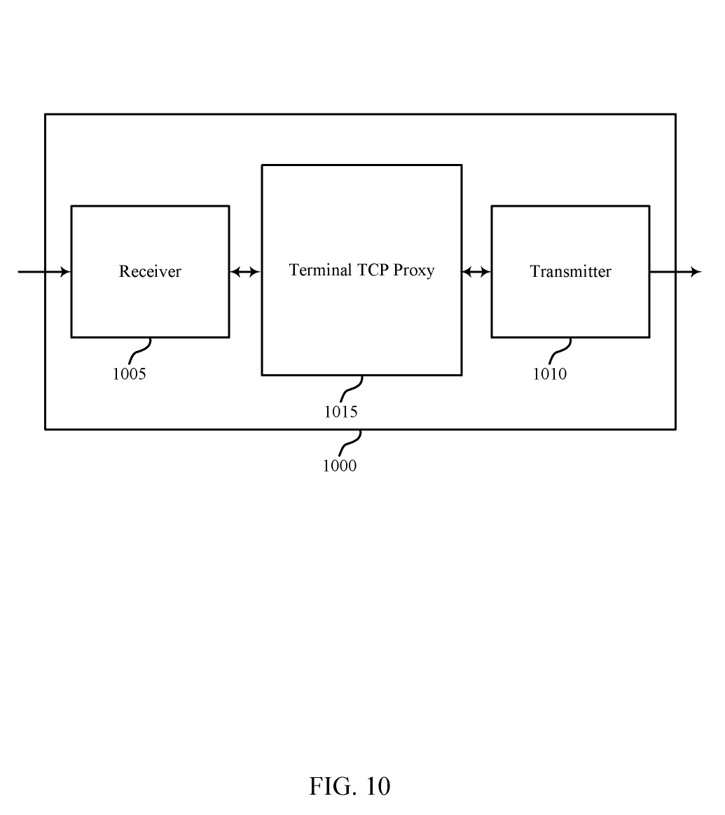

FIG. 10 shows a block diagram of a wireless device 1000 that supports radio-aware TCP rate control in accordance with various aspects of the present disclosure. Wireless device 1000 may be an example of aspects of a UE 115 or a network end device as described with reference to FIGS. 1 and 2. Wireless device 1000 may include receiver 1005, transmitter 1010, and terminal TCP proxy 1015. Wireless device 1000 may also include a processor. Each of these components may be in communication with one another (e.g., via one or more buses).

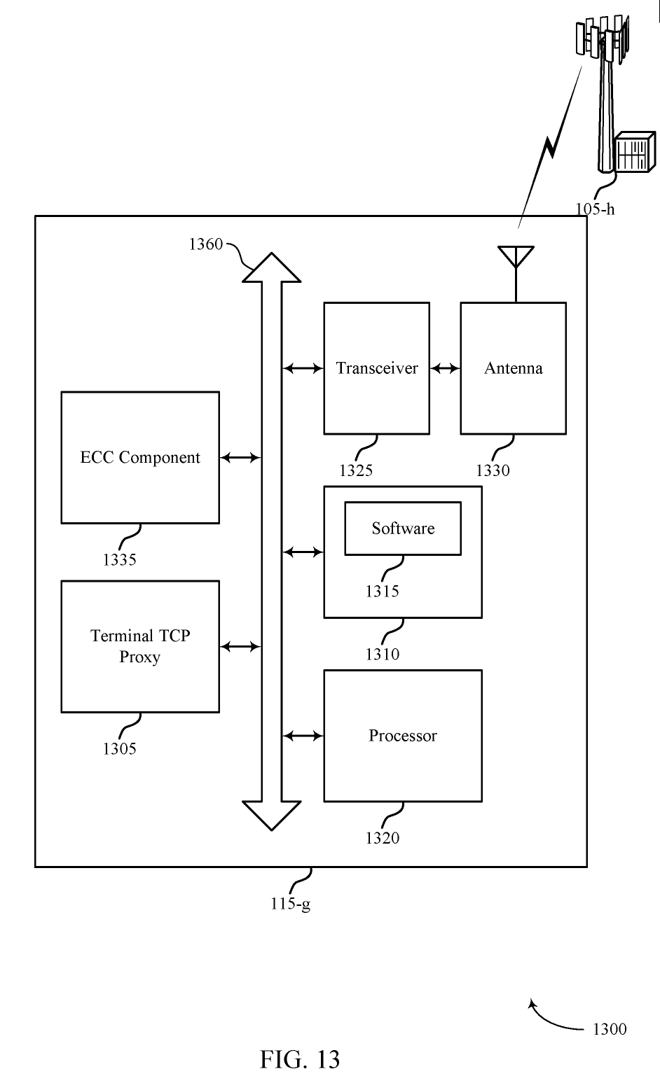

The receiver 1005 may receive information such as packets, user data, or control information associated with various information channels (e.g., control channels, data channels, and information related to radio-aware TCP rate control, etc.). Information may be passed on to other components of the device. The receiver 1005 may be an example of aspects of the transceiver 1325 described with reference to FIG. 13.

The terminal TCP proxy 1015 may establish a TCP connection with an end device. In some examples, the terminal TCP proxy 1015 may determine a dynamic connection parameter associated with the TCP connection. The dynamic connection parameter may include, but is not limited to, at least one of an end to end delay estimate of the TCP connection, or a data rate of the TCP connection, or a MCS associated with the TCP connection, or a minimum queue size of one or more on-path routers, or a queue size estimate of a base station connected to the mobile device, or a combination thereof. In some aspects, the terminal TCP proxy 1015 may receive, from a TCP proxy, an indicator associated with a change in the established TCP connection. A change in the established TCP connection may include at least one of a beginning of a handover event, or an end of a handover event, or a change in a data rate of the TCP connection, or a combination thereof. In further examples, the change in the established TCP connection may include, but is not limited to, a change in an end to end delay estimate of the TCP connection, or an indication of congestion control status, or an indication of retransmission failure, or a combination thereof. The terminal TCP proxy 1015 based on received the indicator may adjust the dynamic connection parameter.

The transmitter 1010 may transmit signals received from other components of wireless device 1000. In some examples, the transmitter 1010 may be collocated with a receiver in a transceiver module. For example, the transmitter 1010 may be an example of aspects of the transceiver 1325 described with reference to FIG. 13. The transmitter 1010 may include a single antenna, or it may include a plurality of antennas.

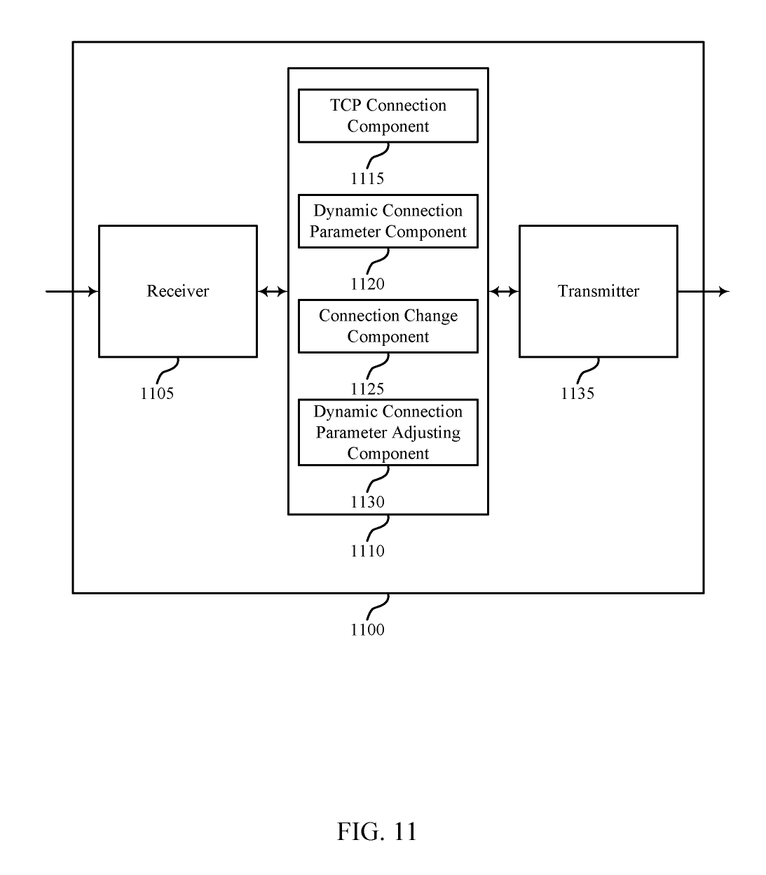

FIG. 11 shows a block diagram of a wireless device 1100 that supports radio-aware TCP in accordance with various aspects of the present disclosure. Wireless device 1100 may be an example of aspects of a wireless device 1000, a network end device, or a UE 115 described with reference to FIGS. 1, 2, and 10. Wireless device 1100 may include a receiver 1105, a terminal TCP proxy 1110, and a transmitter 1135. Wireless device 1100 may also include a processor. Each of these components may be in communication with one another (e.g., via one or more buses).

The receiver 1105 may receive information such as packets, user data, or control information associated with various information channels (e.g., control channels, data channels, and information related to radio-aware TCP rate control, etc.). Information may be passed on to other components of the device. The receiver 1105 may be an example of aspects of the receiver 1005 or 1325 described with reference to FIG. 10 or 13.

The terminal TCP proxy 1110 may be an example of aspects of terminal TCP proxy 1015 described with reference to FIG. 10. The terminal TCP proxy 1110 may also include TCP connection component 1115, dynamic connection parameter component 1120, connection change component 1125, and dynamic connection parameter adjusting component 1130. The terminal TCP proxy 1110 may be an example of aspects of the terminal TCP proxy 1305 described with reference to FIG. 13. In some aspects, terminal TCP proxy 1110 may perform various functions in combination with receiver 1105 and transmitter 1135.

The TCP connection component 1115 may establish a TCP connection with an end device. In some examples, the dynamic connection parameter component 1120 may determine a dynamic connection parameter associated with the TCP connection.

The connection change component 1125 may receive, from a TCP proxy, an indicator associated with a change in the established TCP connection. In some examples, the dynamic connection parameter adjusting component 1130 may adjust the dynamic connection parameter based at least in part on a received indicator. In some aspects, the change in the TCP connection comprises at least one of a beginning of a handover event, or an end of a handover event, or a change in a data rate of the TCP connection, or a change in an end to end delay estimate of the TCP connection, or an indication of congestion control status, or an indication of retransmission failure, or a combination thereof. In some examples, the received indicator includes a suggested congestion window size, a suggested retransmission timeout, or a suggested receive window size.

The transmitter 1135 may transmit signals received from other components of wireless device 1100. In some examples, the transmitter 1135 may be collocated with a receiver in a transceiver module. For example, the transmitter 1135 may be an example of aspects of the transmitter 1010 or 1325 described with reference to FIG. 10 or 13. The transmitter 1135 may utilize a single antenna, or it may utilize a plurality of antennas.

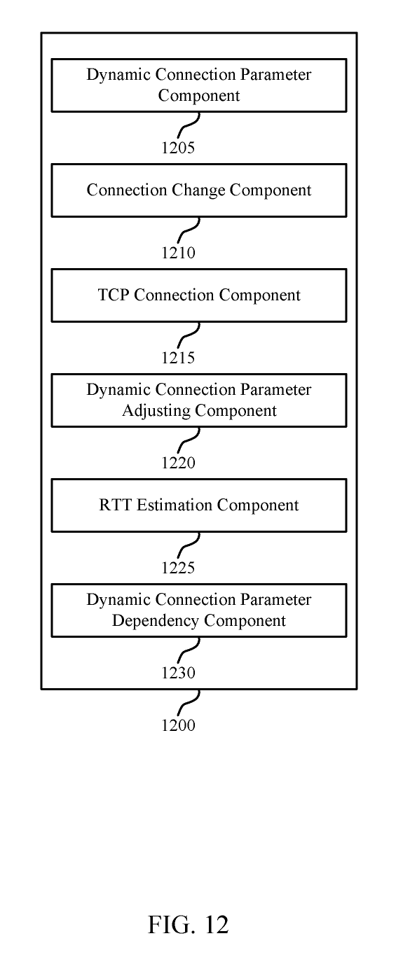

FIG. 12 shows a block diagram of a terminal TCP proxy 1200 which may be an example of the corresponding component of wireless device 1000 or wireless device 1100. In some aspects, terminal TCP proxy 1200 may be an example of terminal TCP proxy 1015 or terminal TCP proxy 1110 described with reference to FIGS. 10 and 11. In some examples, the terminal TCP proxy 1200 may also be an example of aspects of the terminal TCP proxy 1305 described with reference to FIG. 13. In some examples, the terminal TCP proxy 1200 may include dynamic connection parameter component 1205, connection change component 1210, TCP connection component 1215, dynamic connection parameter adjusting component 1220, round trip time (RTT) estimation component 1225, and dynamic connection parameter dependency component 1230. Each of these components may communicate, directly or indirectly, with one another (e.g., via one or more buses).

The dynamic connection parameter component 1205 may determine a dynamic connection parameter associated with the TCP connection. In some aspects, the connection change component 1210 may receive, from a TCP proxy, an indicator associated with a change in the established TCP connection

The TCP connection component 1215 may establish a TCP connection with an end device. In some examples, the dynamic connection parameter adjusting component 1220 may adjust the dynamic connection parameter based on the received indicator. In some examples, the dynamic connection parameter adjusting component 1220 may adjust the dynamic connection parameter based at least in part on a received indicator. In some aspects, the change in the TCP connection comprises at least one of a beginning of a handover event, or an end of a handover event, or a change in a data rate of the TCP connection, or a change in an end to end delay estimate of the TCP connection, or an indication of congestion control status, or an indication of retransmission failure, or a combination thereof. In some examples, the received indicator includes a suggested congestion window size, a suggested retransmission timeout, or a suggested receive window size.

The RTT estimation component 1225 may adjust the dynamic connection parameter based on estimating or suspending estimation of at least one of a smoothed round trip time associated with the TCP connection, or a congestion window size, or a retransmission timeout, or a receive window size, or a combination thereof.

The dynamic connection parameter dependency component 1230 may determine the dynamic connection parameter associated with the TCP connection based on at least one of a connection profile associated with the TCP connection, or a MCS, or upon reception of a TCP ACK message, or upon reception of a TCP negative ACK message, or a BDP, or a combination thereof. In some aspects, the dynamic connection parameter dependency component 1230 may determine that the dynamic connection parameter associated with a TCP connection is based on estimating at least one of a smoothed round trip time associated with the TCP connection, or a congestion window size, or a retransmission timeout, or a receive window size, or a combination thereof.

FIG. 13 illustrates a block diagram of a system 1300 including a UE 115-g that supports radio-aware TCP rate control in accordance with one or more aspects of the present disclosure. UE 115-g may be an example of or include the components of UE 115 as described above, e.g., with reference to FIG. 1. UE 115-g may include components for bi-directional voice and data communications including components for transmitting and receiving communications, including memory 1310, software 1315, processor 1320, transceiver 1325, antenna 1330, ECC component 1335, and terminal TCP proxy 1305. These components may be in electronic communication via bus 1360. UE 115-g may communicate wirelessly with one or more base station (e.g., base station 105-h).

Memory 1310 may include RAM and read only memory ROM. In some examples, the memory 1310 may store computer-readable, computer-executable software including instructions that, when executed, cause the processor to perform various functions described herein. In some cases, the memory 1310 may contain, among other things, a BIOS which may control basic hardware and/or software operation such as the interaction with peripheral components or devices.

Software 1315 may include code to implement aspects of the present disclosure, including code to support techniques for radio-aware TCP rate control. In some examples, software 1315 may be stored in a non-transitory computer-readable medium such as system memory or other memory. In some aspects, the software 1315 may not be directly executable by the processor but may cause a computer (e.g., when compiled and executed) to perform functions described herein

Processor 1320 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some examples, processor 1320 may be configured to operate a memory array using a memory controller. In other examples, a memory controller may be integrated into processor 1320. Processor 1320 may be configured to execute computer-readable instructions stored in a memory to perform various functions (e.g., functions or tasks supporting techniques for TCP rate control).

The terminal TCP proxy 1305 may be an example of a terminal TCP proxy 1015, 1110, or 1200 as described with reference to FIGS. 10 through 12.

Transceiver 1325 may communicate bi-directionally, via one or more antennas, wired, or wireless links as described above. For example, the transceiver 1325 may represent a wireless transceiver and may communicate bi-directionally with another wireless transceiver (e.g., base station 105-h). The transceiver 1325 may also include a modem to modulate the packets and provide the modulated packets to the antennas for transmission, and to demodulate packets received from the antennas. In some examples, the UE 115-g may include a single antenna 1330. However, in some cases the UE 115-g may have more than one antenna 1330, which may be capable of concurrently transmitting or receiving multiple wireless transmissions.

ECC component 1335 may enable operations using EECs such as communication using shared or unlicensed spectrum, using reduced TTIs or subframe durations, or using a large number of component carriers.

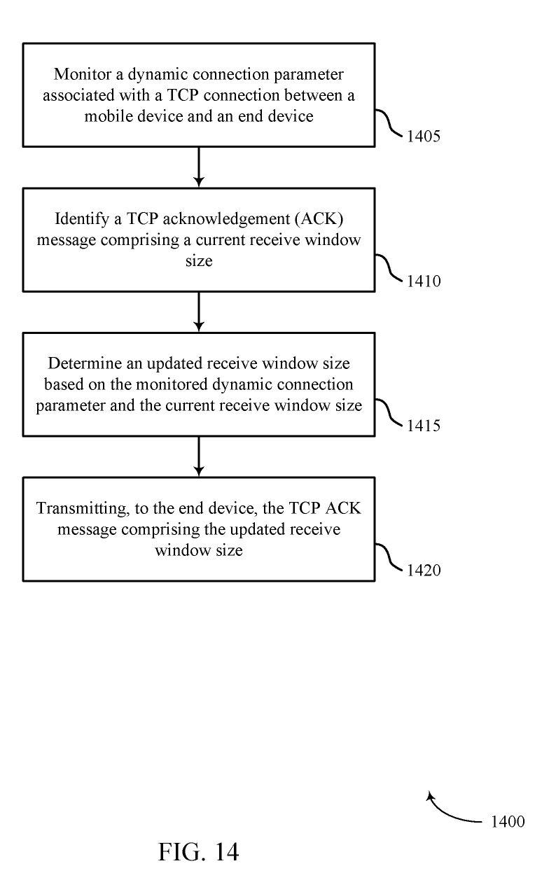

FIG. 14 is a flow chart illustrating an example method 1400 for radio-aware TCP rate control in accordance with one or more aspects of the present disclosure. For clarity, the method 1400 is described below with reference to aspects of one or more base stations 105 described with reference to FIGS. 1-5, or aspects of the wireless device 600 described with reference to FIG. 6, or aspects of the wireless device 700 described with reference to FIG. 7, or aspects of the TCP proxy 615, 710, or 800 described with reference to FIGS. 6-8. In some examples, a base station may execute one or more sets of codes to control the functional elements of the base station to perform the functions described below. Additionally or alternatively, the base station may perform one or more aspects the functions described below using special-purpose hardware. The operations of method 1400 may, additionally or alternatively, be performed by a network device other than a base station 105.

At 1405, the method 1400 may include monitoring a dynamic connection parameter associated with a TCP connection between a mobile device and an end device. In some examples, the base station 105 may monitor a dynamic connection parameter associated with a TCP connection between a mobile device (e.g., UE 115-b) and an end device (e.g., network node 130-b) as described above with reference to FIGS. 2 through 5. In one example, the base station 105 may monitor a TCP connection between a UE 115 and the base station 105 directly. In some examples, the base station 105 may communicate via a TCP connection with the UE 115 through one or more intermediate device, for example, a relay device, or other UEs 115, or other base station(s) 105, or a combination thereof. In some examples, the base station 105 may monitor the TCP connection with the UE 115 base at least in part on the one or more intermediate devices in-path of the base station 105 and the UE 115. In some examples, monitoring the TCP connection may include monitoring a dynamic connection parameter. In some examples, as described elsewhere herein the base station 105 may monitor the dynamic connection parameter associated with the TCP connection directly. In other examples, the base station 105 may monitor the dynamic connection parameter associated with the TCP connection indirectly, for examples, based at least in part on the one or more intermediate devices in-path of the base station 105 and the UE 115 as described with reference to FIG. 1. In some aspects, the operation(s) of 1405 may be performed using the TCP monitoring component 715 or TCP monitoring component 805 as described with reference to FIGS. 7 and 8.

At 1410, the method 1400 may include identifying a TCP ACK message comprising a current receive window size. In some examples, the base station 105 may identify a TCP ACK message comprising a current receive window size as described above with reference to FIGS. 2 through 5. In some aspects, the operation(s) of 1410 may be performed using the TCP ACK component 720 or the TCP ACK component 820 as described with reference to FIGS. 7 and 8.

At 1415, the method 1400 may include determining an updated receive window size based on the monitored dynamic connection parameter and the current receive window size. In some examples, determining the updated receive window size may be based on, but is not limited to, an estimated BDP. In some examples, the base station 105 may determine an updated receive window size based on the monitored dynamic connection parameter and the current receive window size as described above with reference to FIGS. 2 through 5. In some aspects, the operation(s) of 1415 may be performed using the window size component 725 or the window size component 815 as described with reference to FIGS. 7 and 8.

At 1420, the method 1400 may include transmitting, transmitting, to the end device, the TCP ACK message comprising the updated receive window size. In some examples, the base station 105 may transmit to the end device, the TCP ACK message comprising the updated receive window size as described above with reference to FIGS. 2 through 5. In some examples, the base station 105 may transmit the TCP ACK message to an end device via a direct transmission (from the base station 105 directly to the UE 115 or network node 130). In some examples, an end device may be multiple hops from the base station 105. As a result, transmitting the TCP ACK message to an end device may include the base station 105 forwarding the TCP ACK message to one or more intermediate devices in a wireless communication system, and the one or more intermediate devices may forward the TCP ACK message to the end device (UE 115 or network node 130). In some examples, the one or more intermediate devices may include UEs 115 or a network node 130. In some aspects, the operation(s) of 1420 may be performed using the message forwarding component 730 or the message forwarding component 830 as described with reference to FIGS. 7 and 8.

Thus, the method 1400 may provide for radio-aware TCP rate control in accordance with one or more aspects of the present disclosure. It should be noted that the method 1400 is just one implementation and that the operations of the method 1400 may be rearranged or otherwise modified such that other implementations are possible.

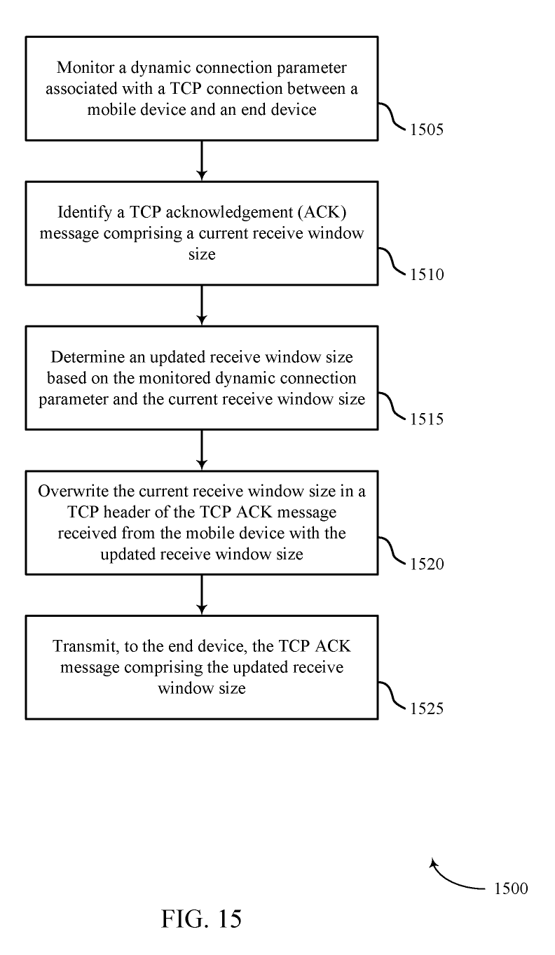

FIG. 15 is a flow chart illustrating an example method 1500 for radio-aware TCP rate control in accordance with one or more aspects of the present disclosure. For clarity, the method 1500 is described below with reference to aspects of one or more base stations 105 described with reference to FIGS. 1-5, or aspects of the wireless device 600 described with reference to FIG. 6, or aspects of the wireless device 700 described with reference to FIG. 7, or aspects of the TCP proxy 615, 710, or 800 described with reference to FIGS. 6-8. In some examples, a base station may execute one or more sets of codes to control the functional elements of the base station to perform the functions described below. Additionally or alternatively, the base station may perform one or more aspects the functions described below using special-purpose hardware. The operations of method 1500 may, additionally or alternatively, be performed by a network device other than a base station 105.

At 1505, the method 1500 may include monitoring a dynamic connection parameter associated with a TCP connection between a mobile device and an end device. In some examples, the base station 105 may monitor a dynamic connection parameter associated with a TCP connection between a mobile device (e.g., UE 115-b) and an end device (e.g., network node 130-b) as described above with reference to FIGS. 2 through 5. In some aspects, the operation(s) of 1505 may be performed using the TCP monitoring component 715 or TCP monitoring component 805 as described with reference to FIGS. 7 and 8.

At 1510, the method 1500 may include identifying a TCP ACK message comprising a current receive window size. In some examples, the base station 105 may identify a TCP ACK message comprising a current receive window size as described above with reference to FIGS. 2 through 5. In some aspects, the operation(s) of 1510 may be performed using the TCP ACK component 720 or the TCP ACK component 820 as described with reference to FIGS. 7 and 8.

At 1515, the method 1500 may include determining an updated receive window size based on the monitored dynamic connection parameter and the current receive window size. In some examples, determining the updated receive window size may be based on, but is not limited to, an estimated BDP. In some examples, the base station 105 may determine an updated receive window size based on the monitored dynamic connection parameter and the current receive window size as described above with reference to FIGS. 2 through 5. In some aspects, the operation(s) of 1515 may be performed using the window size component 725 or the window size component 815 as described with reference to FIGS. 7 and 8.

At 1520, the method 1500 may include overwriting the current receive window size in a TCP header of the TCP ACK message received from the mobile device with the updated receive window size. In some examples, the base station 105 may overwrite the current receive window size in a TCP header of the TCP ACK message received from the mobile device with the updated receive window size as described above with reference to FIGS. 2 through 5. In some aspects, the operation(s) of 1520 may be performed using the window size component 725 or the window size component 815 as described with reference to FIGS. 7 and 8. In some aspects, the operation(s) of 1520 may be performed using the message overwriting component 825 as described with reference to FIG. 8.

At 1525, the method 1500 may include transmitting, transmitting, to the end device, the TCP ACK message comprising the updated receive window size. In some examples, the base station 105 may transmit to the end device, the TCP ACK message comprising the updated receive window size as described above with reference to FIGS. 2 through 5. In some examples, an end device may be multiple hops from the base station 105. As a result, transmitting the TCP ACK message to an end device may include the base station 105 forwarding the TCP ACK message to one or more intermediate devices in a wireless communication system, and the one or more intermediate devices may forward the TCP ACK message to the end device (e.g., UE 115 or network node 130). In some aspects, the operation(s) of 1525 may be performed using the message forwarding component 730 or the message forwarding component 830 as described with reference to FIGS. 7 and 8.

Thus, the method 1500 may provide for radio-aware TCP rate control in accordance with one or more aspects of the present disclosure. It should be noted that the method 1500 is just one implementation and that the operations of the method 1500 may be rearranged or otherwise modified such that other implementations are possible.

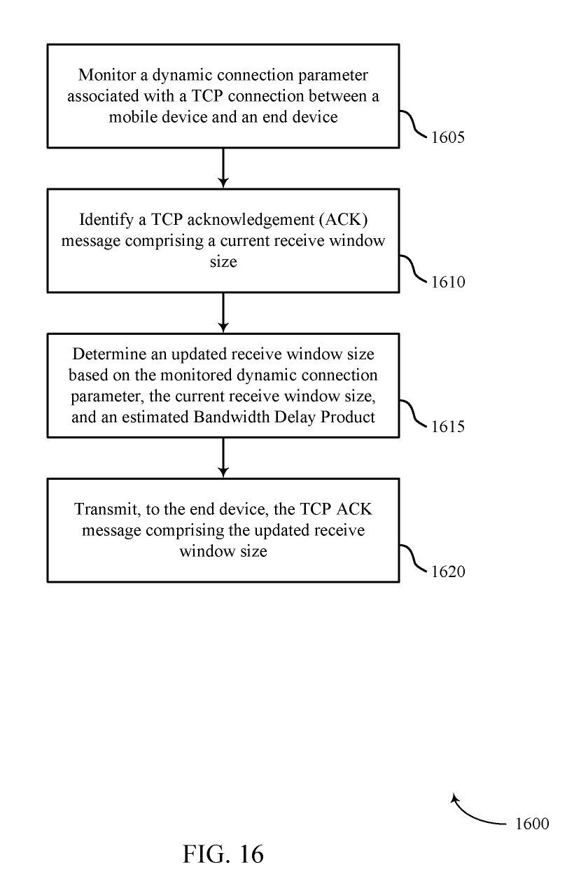

FIG. 16 is a flow chart illustrating an example method 1600 for radio-aware TCP rate control in accordance with one or more aspects of the present disclosure. For clarity, the method 1600 is described below with reference to aspects of one or more base stations 105 described with reference to FIGS. 1-5, or aspects of the wireless device 600 described with reference to FIG. 6, or aspects of the wireless device 700 described with reference to FIG. 7, or aspects of the TCP proxy 615, 710, or 800 described with reference to FIGS. 6-8. In some examples, a base station may execute one or more sets of codes to control the functional elements of the base station to perform the functions described below. Additionally or alternatively, the base station may perform one or more aspects the functions described below using special-purpose hardware. The operations of method 1600 may, additionally or alternatively, be performed by a network device other than a base station 105.

At 1605, the method 1600 may include monitoring a dynamic connection parameter associated with a TCP connection between a mobile device and an end device. In some examples, the base station 105 may monitor a dynamic connection parameter associated with a TCP connection between a mobile device (e.g., UE 115-b) and an end device (e.g., network node 130-b) as described above with reference to FIGS. 2 through 5. In some aspects, the operation(s) of 1605 may be performed using the TCP monitoring component 715 or TCP monitoring component 805 as described with reference to FIGS. 7 and 8.

At 1610, the method 1600 may include identifying a TCP ACK message comprising a current receive window size. In some examples, the base station 105 may identify a TCP ACK message comprising a current receive window size as described above with reference to FIGS. 2 through 5. In some aspects, the operation(s) of 1610 may be performed using the TCP ACK component 720 or the TCP ACK component 820 as described with reference to FIGS. 7 and 8.

At 1615, the method 1600 may include determining an updated receive window size based on the monitored dynamic connection parameter, the current receive window size, and an estimated BDP. In some examples, the base station 105 may determine an updated receive window size based on the monitored dynamic connection parameter, the current receive window size, and an estimated BDP as described above with reference to FIGS. 2 through 5. In some aspects, the operation(s) of 1615 may be performed using the window size component 725 or the window size component 815 as described with reference to FIGS. 7 and 8.

At 1620, the method 1600 may include transmitting, to the end device, the TCP ACK message comprising the updated receive window size. In some examples, the base station 105 may transmit to the end device, the TCP ACK message comprising the updated receive window size as described above with reference to FIGS. 2 through 5. In some examples, the base station 105 may transmit the TCP ACK message to an end device via a direct transmission (from the base station 105 directly to the UE 115 or network node 130). In some examples, an end device may be multiple hops from the base station 105. As a result, transmitting the TCP ACK message to an end device may include the base station 105 forwarding the TCP ACK message to one or more intermediate devices in a wireless communication system (e.g., multiple-hop relay devices, other UEs, among others), and the one or more intermediate devices may forward the TCP ACK message to the end device (UE 115 or network node 130). In some examples, the one or more intermediate devices may include UEs 115 or a network node (e.g., network node 130-a). In some aspects, the operation(s) of 1620 may be performed using the message forwarding component 730 or the message forwarding component 830 as described with reference to FIGS. 7 and 8.

Thus, the method 1600 may provide for radio-aware TCP rate control in accordance with one or more aspects of the present disclosure. It should be noted that the method 1600 is just one implementation and that the operations of the method 1600 may be rearranged or otherwise modified such that other implementations are possible.

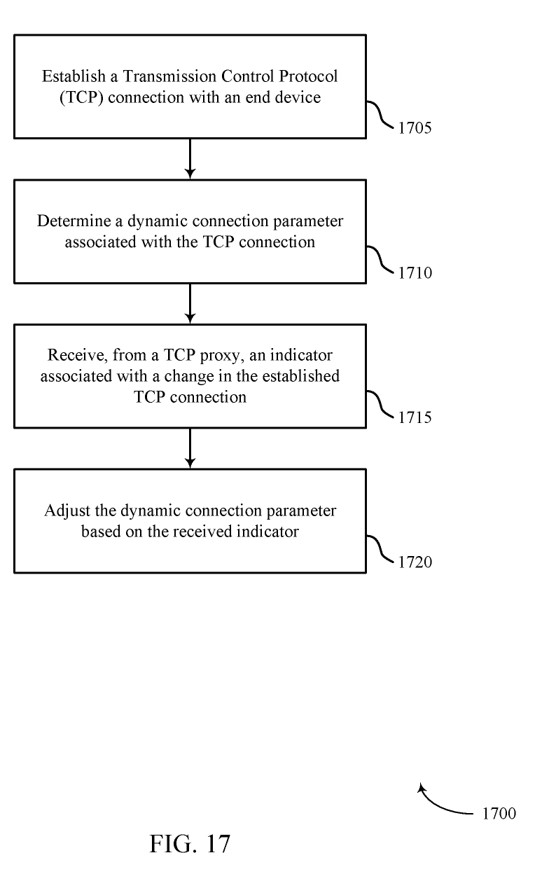

FIG. 17 is a flow chart illustrating an example method 1700 for radio-aware TCP rate control in accordance with one or more aspects of the present disclosure. For clarity, the method 1700 is described below with reference to aspects of one or more of the UEs 115 described with reference to FIGS. 1-5, or aspects of the wireless device 1000 described with reference to FIG. 10, or aspects of the wireless device 1100 described with reference to FIG. 11, or aspects of the terminal TCP proxy 1015, 1110, or 1200 described with reference to FIGS. 10-12. In some examples, a wireless device (e.g., a UE, an apparatus, or a TCP proxy) may execute one or more sets of codes to control the functional elements of the wireless device to perform the functions described below. Additionally or alternatively, the wireless device may perform one or more aspects the functions described below using special-purpose hardware. The operations of method 1700 may, additionally or alternatively, be performed by a network device other than a UE 115.

At 1705, the method 1700 may include establishing a TCP connection with an end device. In some examples, the UE 115 may establish a TCP connection with an end device as described above with reference to FIGS. 2 through 5. In some aspects, the operation(s) of 1705 may be performed using the TCP connection component 1115 or TCP connection component 1215 described with reference to FIGS. 11 and 12.

At 1710, the method 1700 may include determining a dynamic connection parameter associated with the TCP connection. In some examples, the UE 115 may determine a dynamic connection parameter associated with the TCP connection as described above with reference to FIGS. 2 through 5. In some examples, the UE 115 may determine a dynamic connection parameter associated with the TCP connection as described above with reference to FIGS. 2 through 5. In some examples, the dynamic connection parameter may include, but is not limited to at least one of an end to end delay estimate of the TCP connection, or a data rate of the TCP connection, or a MCS associated with the TCP connection, or a combination thereof. In other examples, the dynamic connection parameter may include, but is not limited to at least one of a minimum queue size of one or more on-path routers, or a queue size estimate of a base station connected to the mobile device, or a combination thereof. In some aspects, the operation(s) of 1710 may be performed using the dynamic connection parameter component 1120 or dynamic connection parameter component 1205 as described with reference to FIGS. 11 and 12.

At 1715, the method 1700 may include receiving, from a TCP proxy, an indicator associated with a change in the established TCP connection. In some examples, the UE 115 may receive, from a TCP proxy, an indicator associated with a change in the established TCP connection as described above with reference to FIGS. 2 through 5. In some aspects, the operation(s) of 1715 may be performed using the connection change component 1125 or the connection change component 1210 as described with reference to FIGS. 11 and 12.

At 1720, the method 1700 may include adjusting the dynamic connection parameter based on the received indicator. In some examples, the UE 115 may adjust the dynamic connection parameter based on the received indicator as described above with reference to FIGS. 2 through 5. In some aspects, the operation(s) of 1720 may be performed using the dynamic connection parameter adjusting component 1130 or the dynamic connection parameter adjusting component 1220 as described with reference to FIGS. 11 and 12.

Thus, the method 1700 may provide for radio-aware TCP rate control in accordance with one or more aspects of the present disclosure. It should be noted that the method 1700 is just one implementation and that the operations of the method 1700 may be rearranged or otherwise modified such that other implementations are possible.

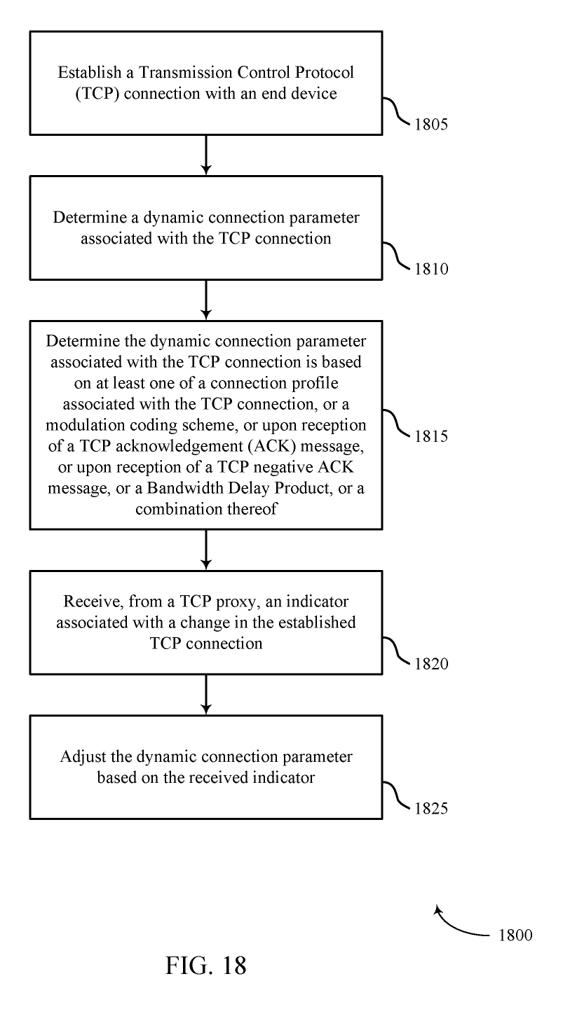

FIG. 18 is a flow chart illustrating an example method 1800 for radio-aware TCP rate control in accordance with one or more aspects of the present disclosure. For clarity, the method 1800 is described below with reference to aspects of one or more of the UEs 115 described with reference to FIGS. 1-5, or aspects of the wireless device 1000 described with reference to FIG. 10, or aspects of the wireless device 1100 described with reference to FIG. 11, or aspects of the terminal TCP proxy 1015, 1110, or 1200 described with reference to FIGS. 10-12. In some examples, a wireless device (e.g., a UE, an apparatus, or a TCP proxy) may execute one or more sets of codes to control the functional elements of the wireless device to perform the functions described below. Additionally or alternatively, the wireless device may perform one or more aspects the functions described below using special-purpose hardware. The operations of method 1800 may, additionally or alternatively, be performed by a network device other than a UE 115.

At 1805, the method 1800 may include establishing a TCP connection with an end device. In some examples, the UE 115 may establish a TCP connection with an end device as described above with reference to FIGS. 2 through 5. In some aspects, the operation(s) of 1805 may be performed using the TCP connection component 1115 or TCP connection component 1215 described with reference to FIGS. 11 and 12.

At 1810, the method 1800 may include determining a dynamic connection parameter associated with the TCP connection. In some examples, the UE 115 may determine a dynamic connection parameter associated with the TCP connection as described above with reference to FIGS. 2 through 5. In some examples, the dynamic connection parameter may include, but is not limited to at least one of an end to end delay estimate of the TCP connection, or a data rate of the TCP connection, or a MCS associated with the TCP connection, or a minimum queue size of one or more on-path routers, or a queue size estimate of a base station connected to the mobile device, or a combination thereof. In some aspects, the operation(s) of 1810 may be performed using the dynamic connection parameter component 1120 or dynamic connection parameter component 1205 as described with reference to FIGS. 11 and 12.

At 1815, the method 1800 may include determining the dynamic connection parameter associated with the TCP connection is based on at least one of a connection profile associated with the TCP connection, or a MCS, or upon reception of a TCP ACK message, or upon reception of a TCP negative ACK message, or a BDP, or a combination thereof. In some examples, the UE 115 may determine the dynamic connection parameter associated with the TCP connection is based on at least one of a connection profile associated with the TCP connection, or a MCS, or upon reception of a TCP ACK message, or upon reception of a TCP negative ACK message, or a BDP, or a combination thereof as described above with reference to FIGS. 2 through 5. In some aspects, the operation(s) of 1815 may be performed using the dynamic connection parameter dependency component 1230 as described with reference to FIG. 12.

At 1820, the method 1800 may include receiving, from a TCP proxy, an indicator associated with a change in the established TCP connection. In some examples, the UE 115 may receive from a TCP proxy, an indicator associated with a change in the established TCP connection as described above with reference to FIGS. 2 through 5. In some aspects, the operation(s) of 1820 may be performed using the connection change component 1125 or the connection change component 1210 as described with reference to FIGS. 11 and 12.

At 1825, the method 1800 may include adjusting the dynamic connection parameter based on the received indicator. In some examples, the UE 115 may the dynamic connection parameter based on the received indicator as described above with reference to FIGS. 2 through 5. In some aspects, the operation(s) of 1825 may be performed using the dynamic connection parameter adjusting component 1130 or the dynamic connection parameter adjusting component 1220 as described with reference to FIGS. 11 and 12.

Thus, the method 1800 may provide for radio-aware TCP rate control in accordance with one or more aspects of the present disclosure. It should be noted that the method 1800 is just one implementation and that the operations of the method 1800 may be rearranged or otherwise modified such that other implementations are possible.

In some examples, aspects from two or more of the methods 1400, 1500, 1600, 1700, or 1800 described with reference to FIG. 14, 15, 16, 17, or 18 may be combined. It should be noted that the methods 1400, 1500, 1600, 1700, and 1800 are just example implementations, and that the operations of the methods 1400, 1500, 1600, 1700, or 1800 may be rearranged or otherwise modified such that other implementations are possible.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different (physical) locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as (Global System for Mobile (GSM) communications). An OFDMA system may implement a radio technology such as Ultra Mobile Broadband (UMB), Evolved UTRA (E-UTRA), Institute of Electrical and Electronic Engineers (IEEE) 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some examples, different coverage areas may be associated with different communication technologies. In some aspects, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication at a Transmission Control Protocol (TCP) proxy, comprising:
monitoring a dynamic connection parameter associated with a TCP connection between a mobile device and an end device;
identifying a TCP acknowledgement (ACK) message comprising a current receive window size;
determining an updated receive window size based at least in part on the monitored dynamic connection parameter and the current receive window size; and
transmitting, to the end device, the TCP ACK message comprising the updated receive window size.

2. The method of claim 1, further comprising:
overwriting the current receive window size in a TCP header of the TCP ACK message received from the mobile device with the updated receive window size.

3. The method of claim 1, wherein the dynamic connection parameter comprises at least one of an end to end delay estimate of the TCP connection, or a data rate of the TCP connection, or a modulation coding scheme associated with the TCP connection, or a minimum queue size of one or more on-path routers, or a queue size estimate of a base station connected to the mobile device, or a combination thereof.

4. The method of claim 1, wherein determining the updated receive window size comprises:
determining a change in the monitored dynamic connection parameter; and
adjusting the current receive window size based at least in part on the determined change.

5. The method of claim 4, wherein adjusting the current receive window size comprises:
reducing the current receive window size based at least in part on the monitored dynamic connection parameter.

6. The method of claim 1, further comprising:
determining the updated receive window size is based at least in part on an estimated Bandwidth Delay Product.

7. The method of claim 1, wherein the TCP proxy is collocated with the mobile device, the end device, or a network node along a path of the TCP connection.

8. The method of claim 1, wherein determining the updated receive window size comprises:
calculating a maximum receive window size based at least in part on the monitored dynamic connection parameter; and
selecting the updated receive window size based on a minimum of the calculated maximum receive window size and the current receive window size received from the mobile device in the TCP ACK message.

9. An apparatus for wireless communication, comprising:
a processor;
memory in electronic communication with the processor; and the processor and memory configured to:
monitor a dynamic connection parameter associated with a transmission control protocol (TCP) connection between a mobile device and an end device;
identify a TCP acknowledgement (ACK) message comprising a current receive window size;
determine an updated receive window size based at least in part on the monitored dynamic connection parameter and the current receive window size; and
transmit, to the end device, the TCP ACK message comprising the updated receive window size.

10. The apparatus of claim 9, wherein the processor and the memory are further configured to:
overwrite the current receive window size in a TCP header of the TCP ACK message received from the mobile device with the updated receive window size.

11. The apparatus of claim 9, wherein the dynamic connection parameter comprises at least one of an end to end delay estimate of the TCP connection, or a data rate of the TCP connection, or a modulation coding scheme associated with the TCP connection, or a minimum queue size of one or more on-path routers, or a queue size estimate of a base station connected to the mobile device, or a combination thereof.

12. The apparatus of claim 9, wherein determining the updated receive window size comprises the processor and the memory further configured to:
determine a change in the monitored dynamic connection parameter; and
adjust the current receive window size based at least in part on the determined change.

13. The apparatus of claim 12, wherein adjusting the updated receive window size comprises the processor and the memory further configured to:
reduce the current receive window size based at least in part on the monitored dynamic connection parameter.

14. The apparatus of claim 9, wherein the processor and the memory are further configured to:
determine the updated receive window size is based at least in part on an estimated Bandwidth Delay Product.

15. A method of wireless communication at a Transmission Control Protocol (TCP) end device, comprising:
establishing a Transmission Control Protocol (TCP) connection with an end device;
determining a dynamic connection parameter associated with the TCP connection;
receiving, from a TCP proxy, an indicator associated with a change in the established TCP connection; and
adjusting the dynamic connection parameter based at least in part on the received indicator.

16. The method of claim 15, wherein adjusting the dynamic connection parameter comprises: estimating or suspending estimation of at least one of a smoothed round trip time associated with the TCP connection, or a congestion window size, or a retransmission timeout, or a receive window size, or a combination thereof.

17. The method of claim 15, further comprising:
determining the dynamic connection parameter associated with the TCP connection is based at least in part on at least one of a connection profile associated with the TCP connection, or a modulation coding scheme, or upon reception of a TCP acknowledgement (ACK) message, or upon reception of a TCP negative ACK message, or a Bandwidth Delay Product, or a combination thereof.

18. The method of claim 15, wherein determining the dynamic connection parameter associated with the TCP connection comprises: estimating at least one of a smoothed round trip time associated with the TCP connection, or a congestion window size, or a retransmission timeout, or a receive window size, or a combination thereof.

19. The method of claim 15, wherein the change in the TCP connection comprises at least one of a beginning of a handover event, or an end of a handover event, or a change in a data rate of the TCP connection, or a change in an end to end delay estimate of the TCP connection, or an indication of congestion control status, or an indication of retransmission failure, or a combination thereof.

20. The method of claim 15, wherein the received indicator comprises a suggested congestion window size, a suggested retransmission timeout, or a suggested receive window size.
